(19) United States
(12) Patent Application Publication
(10) Pub. No.: US 2019/0322807 A1
(43) Pub. Date: Oct. 24, 2019

(54) POLYIMIDE, POLYAMIC ACID, SOLUTIONS THEREOF, AND FILM USING POLYIMIDE

(71) Applicant: JXTG NIPPON OIL & ENERGY CORPORATION, Tokyo (JP)

(72) Inventors: Daisuke WATANABE, Tokyo (JP); Rieko FUJISHIRO, Tokyo (JP); Takahiro HASEGAWA, Tokyo (JP); Asako KYOBU, Tokyo (JP)

(73) Assignee: JXTG NIPPON OIL & ENERGY CORPORATION, Tokyo (JP)

(21) Appl. No.: 16/332,601

(22) PCT Filed: Sep. 7, 2017
(86) PCT No.: PCT/JP2017/032293

§ 371 Date: Mar. 12, 2019

(30) Foreign Application Priority Data
Sep. 13, 2016 (JP) 2016-178869

(51) Int. Cl. C08G 73/10; C08J 3/11; C08J 5/18

(52) U.S. Cl. CPC C08G 73/1042; C08G 73/1078; C08J 2379/08; C08J 3/11; C08J 5/18; C08G 73/1032

(57) ABSTRACT

A polyimide, comprising at least one repeating unit selected from the group consisting of a repeating unit (A1) represented by a particular general formula, a repeating unit (B1) represented by a particular general formula, and a repeating unit (C1) represented by a particular general formula.

### TECHNICAL FIELD

The present invention relates to a polyimide, a polyamic acid, solutions thereof (polyimide solution and polyamic acid solution), and a film using a polyimide.

### BACKGROUND ART

Recently, in the field of, for example, display devices such as liquid-crystal displays and displays using organic electroluminescent elements, there have been demands for the development of a material which has a high light transmittance andasufficientlyhighheat resistance like glass and which is also light and flexible. In addition, as a material used for such glass substitute application or the like, attention has been focusedon films made of light and flexible polyimide with high heat resistance.

As such a polyimide, for example, an aromatic polyimide (for example, trade name “Kapton” manufactured by DuPont) has been known. However, although such an aromatic polyimide has a sufficient flexibility and a high heat resistance, the polyimide is colored in brown and cannot be used in glass substitute application, optical application, and the like where light transmittance is necessary.

For this reason, recently, the development of alicyclic polyimides having sufficient heat resistances and sufficient light transmittances has been advanced for the uses in glass substitute application and the like. For example, International Publication No. WO2011/099518 (PTL 1) and International Publication No. WO2015/163314 (PLT 2) each disclose a polyimide having a repeating unit represented by a particular general formula.

### CITATION LIST

### Patent Literature

[PTL 1] International Publication No. WO2011/099518
[PTL 2] International Publication No. WO2015/163314

### SUMMARY OF INVENTION

### Technical Problem

The above-described polyimides described in PTL 1 and PTL 2 each can be considered to have a sufficient heat resistance and be sufficiently colorless and transparent, and can be used for various applications. However, in the field of polyimide, there have been demands for the development of a polyimide which has a higher level of heat resistance based on the glass transition temperature, while retaining such transparency sufficiently.

The present invention has been made in view of the problems of the above-described conventional techniques, and an object of the present invention is to provide a polyimide which can achieve a higher level of heat resistance based on the glass transition temperature, a polyimide solution comprising the polyimide, and a film using the polyimide. Moreover, another object of the present invention is to provide a polyamic acid which can be preferably used to produce the polyimide and a polyamic acid solution comprising the polyamic acid.

### Solution to Problem

The present inventors have conducted intensive study to achieve the above-described objects, and consequently have found that when a polyimide comprises at least one repeating unit selected from the group consisting of a repeating unit (A1) described below, a repeating unit (B1) described below, and a repeating unit (C1) described below, the polyimide can achieve a higher level of heat resistance based on the glass transition temperature. This finding has led to the completion of the present invention.

A polyimide of the present invention comprises at least one repeating unit selected from the group consisting of:

a repeating unit (A1) represented by the following general formula (1):

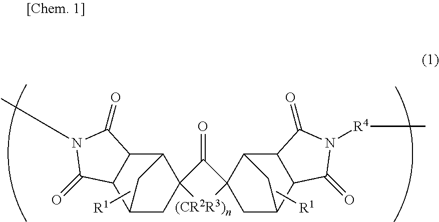

[in the formula (1), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the following general formula (X):

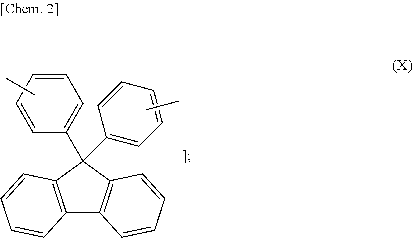

a repeating unit (B1) represented by the following general formula (2):

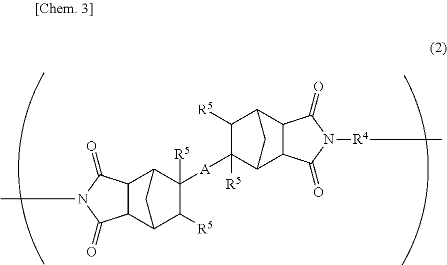

[in the formula (2), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms]; and

a repeating unit (C1) represented by the following general formula (3):

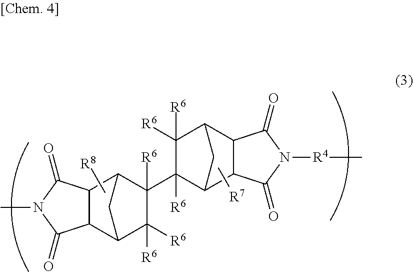

[in the formula (3), R⁴ represents an arylene group represented by the general formula (X), and multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms].

Meanwhile, a polyamic acid of the present invention comprises at least one repeating unit selected from the group consisting of:

a repeating unit (A2) represented by the following general formula (4):

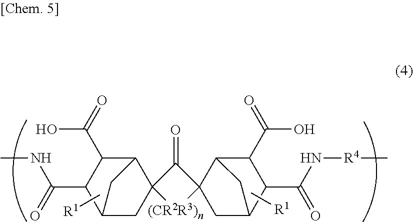

[in the formula (4), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the following general formula (X):

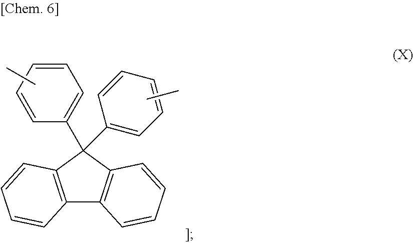

a repeating unit (B2) represented by the following general formula (5):

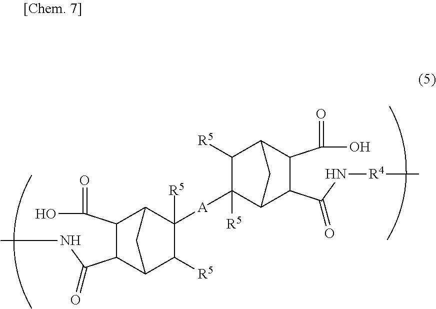

[in the formula (5), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms]; and

a repeating unit (C2) represented by the following general formula (6):

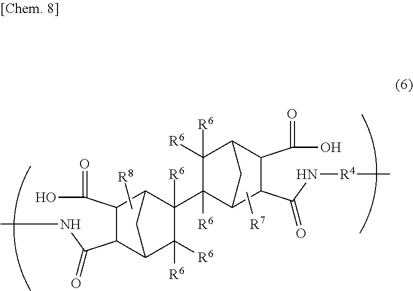

[in the formula (6), R⁴ represents an arylene group represented by the general formula (X), and multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms].

Moreover, a polyimide solution of the present invention comprises: the above-described polyimide of the present invention; and an organic solvent. Meanwhile, a polyamic acid solution of the present invention comprises: the above-described polyamic acid of the present invention; and an organic solvent. A resin solution (varnish) such as the polyimide solution or the polyamic acid solution makes it possible to efficiently produce a polyimide in various forms.

In addition, a polyimide film of the present invention comprises the above-described polyimide of the present invention.

### Advantageous Effects of Invention

According to the present invention, it is possible to provide a polyimide which can achieve a higher level of heat resistance based on the glass transition temperature, a polyimide solution comprising the polyimide, and a film using the polyimide. Moreover, according to the present invention, it is possible to provide a polyamic acid which can be preferably used to produce the polyimide, and a polyamic acid solution comprising the polyamic acid.

### DESCRIPTION OF EMBODIMENTS

Hereinafter, the present invention will be described in detail based on preferred embodiments thereof.

[Polyimide]

A polyimide of the present invention comprises at least one repeating unit selected from the group consisting of:

a repeating unit (A1) represented by the following general formula (1):

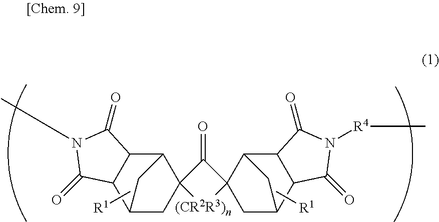

[in the formula (1), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the following general formula (X):

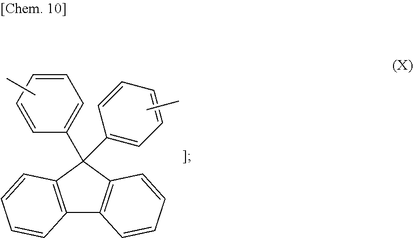

a repeating unit (B1) represented by the following general formula (2):

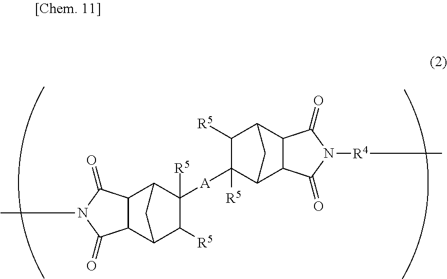

[in the formula (2), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms]; and

a repeating unit (C1) represented by the following general formula (3):

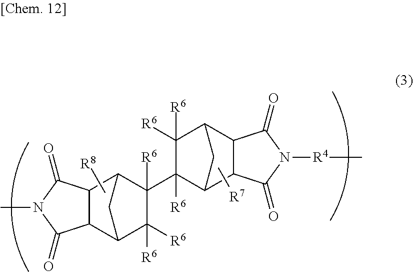

[in the formula (3), R⁴ represents an arylene group represented by the general formula (X), and multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms]. First, each repeating unit is described below.

<Repeating Unit (A1)>

The repeating unit (A1) which may be contained in the polyimide of the present invention is a repeating unit represented by the above-described general formula (1) (note that, in the general formula (1), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the general formula (X)).

The alkyl group which can be selected as any one of R¹s, R², and R³ in the general formula (1) is an alkyl group having 1 to 10 carbon atoms. If the number of carbon atoms exceeds 10, the glass transition temperature is lowered, so that a sufficiently high heat resistance cannot be achieved. In addition, the number of carbon atoms of the alkyl group which can be selected as any one of R¹s, R², and R³ is preferably 1 to 6, more preferably 1 to 5, further preferably 1 to 4, and particularly preferably 1 to 3, from the viewpoint that the purification becomes easier. In addition, the alkyl group which can be selected as any one of R¹s, R², and R³ may be linear or branched. Further, the alkyl group is more preferably a methyl group or an ethyl group from the viewpoint of ease of purification.

R¹s, R², and R³ in the general formula (1) are more preferably each independently a hydrogen atom or an alkyl group having 1 to 10 carbon atoms, from the viewpoint that a higher heat resistance is obtained when a polyimide is produced. In particular, R¹s, R², and R³ in the general formula (1) are each independently more preferably a hydrogen atom, a methyl group, an ethyl group, a n-propyl group, or an isopropyl group, and particularly preferably a hydrogen atom or a methyl group, from the viewpoints that the raw materials are readily available, and that the purification is easier. In addition, the multiple R¹s, R², and R³ in the formula are particularly preferably the same, from the viewpoints of ease of purification and the like.

In addition, the arylene group which can be selected as R⁴ in the general formula (1) is an arylene group represented by the general formula (X). The use of such an arylene group makes it possible to achieve a higher level of heat resistance based on the glass transition temperature than those of conventional polyimides. In addition, the arylene group represented by the general formula (X) is particularly preferably a group represented by the following general formula (X-1):

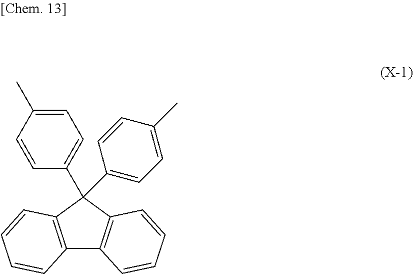

from the viewpoint of synthetic ease and convenience.

Further, n in the general formula (1) represents an integer of 0 to 12. If the value of n exceeds the upper limit, the purification becomes difficult. In addition, an upper limit value of the numeric value range of n in the general formula (1) is more preferably 5, and particularly preferably 3, from the viewpoint that the purification becomes easier. In addition, a lower limit value of the numeric value range of n in the general formula (1) is more preferably 1, and particularly preferably 2, from the viewpoint of the stability of the raw material compound. Accordingly, n in the general formula (1) is particularly preferably an integer of 2 or 3.

The repeating unit (A1) represented by the general formula (1) can be derived from a raw material compound (A) represented by the following general formula (101):

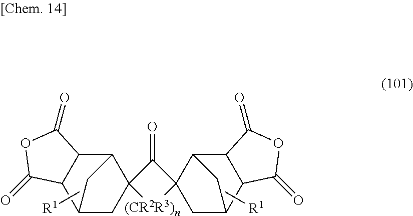

[in the formula (101), R¹s, R², R³, and n have the same meanings as those of R¹s, R², R³, and n in the general formula (1) (preferred ones thereof are also the same as those of R¹s, R², R³, and n in the general formula (1))] and an aromatic diamine represented by the following general formula (102):

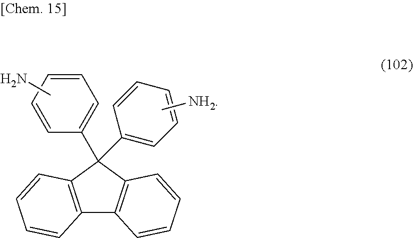

For example, the repeating unit (A1) represented by the general formula (1) can be contained in the polyimide by reacting the raw material compound (A) with the aromatic diamine to form a polyamic acid comprising a repeating unit (A2) described later, followed by imidization of the polyamic acid. Specific reaction conditions, conditions which can be preferably employed for the imidization method, and the like are described later.

Note that a method for producing the tetracarboxylic dianhydride represented by the general formula (101) is not particularly limited, and a known method can be employed, as appropriate. For example, a method described in International Publication No. WO2011/099517, a method described in International Publication No. WO2011/099518, or the like may be employed.

In addition, a method for producing the aromatic diamine represented by the general formula (102) is not particularly limited, and a known method can be employed, as appropriate. In addition, a commercially available one may be used, as appropriate, as the aromatic diamine. In addition, one of such aromatic diamines represented by the general formula (102) may be used alone, or two or more thereof may be used in combination.

<Repeating Unit (B1)>

The repeating unit (B1) which may be contained in the polyimide of the present invention is a repeating unit represented by the above-described general formula (2) (note that, in the general formula (2), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms).

A in the general formula (2) is an optionally substituted divalent aromatic group as described above, and the number of carbon atoms forming an aromatic ring contained in the aromatic group is 6 to 30 (note that, in a case where the aromatic group has a carbon-containing substituent(s) (such as a hydrocarbon group(s)), “the number of carbon atoms forming an aromatic ring” herein does not include the number of carbon atoms in the substituent(s), but refers to only the number of carbon atoms of the aromatic ring in the aromatic group. For example, in the case of a 2-ethyl-1,4-phenylene group, the number of carbon atoms forming the aromatic ring is 6). As described above, A in the general formula (1) is an optionally substituted divalent group (divalent aromatic group) having an aromatic ring having 6 to 30 carbon atoms. If the number of carbon atoms forming an aromatic ring exceeds the upper limit, it tends to be difficult to sufficiently suppress color development of a polyimide containing the repeating unit. In addition, from the viewpoints of transparency and ease of purification, the number of carbon atoms forming the aromatic ring of the divalent aromatic group is more preferably 6 to 18, and further preferably 6 to 12.

In addition, the divalent aromatic groups are not particularly limited, as long as the above-described condition of the number of carbon atoms is satisfied. For example, it is possible to use, as appropriate, residues formed when two hydrogen atoms are eliminated from aromatic compounds such as benzene, naphthalene, terphenyl, anthracene, phenanthrene, triphenylene, pyrene, chrysene, biphenyl, terphenyl, quaterphenyl, and quinquephenyl (note that, regarding these residues, the positions at which the hydrogen atoms are eliminated are not particularly limited, and examples thereof include a 1,4-phenylene group, a 2,6-naphthylene group, a 2,7-naphthylene group, a 4,4′-biphenylene group, a 9,10-anthracenylene group, and the like); and groups formed when at least one hydrogen atom is replaced with a substituent in the above-described residues (for example, a 2,5-dimethyl-1,4-phenylene group and a 2,3,5,6-tetramethyl-1,4-phenylene group), and the like. Note that, in these residues, the positions at which the hydrogen atoms are eliminated are not particularly limited as described above, and, for example, when the residue is a phenylene group, the positions may be any of ortho, meta, and para to each other.

The divalent aromatic groups are preferably optionally substituted phenylene groups, optionally substituted biphenylene groups, optionally substituted naphthylene groups, optionally substituted anthracenylene groups, and optionally substituted terphenylene groups, from the viewpoint that, when a polyimide is produced, the polyimide has better solubility in solvent and offers a higher processability. In other words, these divalent aromatic groups are preferably phenylene groups, biphenylene groups, naphthylene groups, anthracenylene groups, and terphenylene groups, each of which is optionally substituted. In addition, of these divalent aromatic groups, phenylene groups, biphenylene groups, and naphthylene groups, each of which is optionally substituted, are more preferable, phenylene groups and biphenylene group, each of which is optionally substituted, are further preferable, and optionally substituted phenylene groups are the most preferable, because a higher effect can be obtained from the above-described viewpoint.

In addition, in A in the general formula (2), the substituents which may be present on the divalent aromatic groups are not particularly limited, and examples thereof include alkyl groups, alkoxy groups, halogen atoms, and the like. Of these substituents which may be present on the divalent aromatic groups, alkyl groups having 1 to 10 carbon atoms and alkoxy groups having 1 to 10 carbon atoms are more preferable, from the viewpoint that, when a polyimide is produced, the polyimide has better solubility in solvent and offers a higher processability. If the number of carbon atoms of each of the alkyl groups and the alkoxy groups preferable as the substituents exceeds 10, the heat resistance of a polyimide obtained in the use as a monomer for the polyimide tends to be lowered. In addition, the number of carbon atoms of each of the alkyl groups and the alkoxy groups preferable as the substituents is preferably 1 to 6, more preferably 1 to 5, further preferably 1 to 4, and particularly preferably 1 to 3, from the viewpoint that a higher heat resistance can be obtained when a polyimide is produced. In addition, each of the alkyl groups and the alkoxy groups which may be selected as the substituents may be linear or branched.

In addition, of these divalent aromatic groups, phenylene groups, biphenylene groups, naphthylene groups, anthracenylene groups, and terphenylene groups, each of which is optionally substituted, are preferable, phenylene groups, biphenylene groups, and naphthylene groups, each of which is optionally substituted, are more preferable, phenylene groups and biphenylene groups, each of which is optionally substituted, are further preferable, and optionally substituted phenylene groups are the most preferable, from the viewpoint that, when a polyimide is produced, the polyimide has better solubility in solvent and offers a higher processability.

Moreover, of these divalent aromatic groups, phenylene groups, biphenylene groups, naphthylene groups, anthracenylene groups, and terphenylene groups, each of which is optionally substituted, are preferable, phenylene groups, biphenylene groups, naphthylene groups, and terphenylene groups, each of which is optionally substituted, are more preferable, phenylene groups, biphenylene groups, and naphthylene groups, each of which is optionally substituted, are further preferable, and optionally substituted phenylene groups are the most preferable, from the viewpoint that a higher heat resistance can be obtained.

In addition, in A in the general formula (2), the substituents which may be present on the divalent aromatic groups are not particularly limited, and examples thereof include alkyl groups, alkoxy groups, halogen atoms, and the like. Of these substituents which may be present on the divalent aromatic groups, alkyl groups having 1 to 10 carbon atoms and alkoxy groups having 1 to 10 carbon atoms are more preferable, from the viewpoint that the polyimide has better solubility in solvent and offers a higher processability. If the number of carbon atoms of each of the alkyl groups and the alkoxy groups preferable as the substituents exceeds 10, the heat resistance of the polyimide tends to be lowered. In addition, the number of carbon atoms of each of the alkyl groups and the alkoxy groups preferable as the substituents is preferably 1 to 6, more preferably 1 to 5, further preferably 1 to 4, and particularly preferably 1 to 3, from the viewpoint that a higher heat resistance is obtained. In addition, each of the alkyl groups and the alkoxy groups which may be selected as the substituents may be linear or branched.

In addition, the alkyl group which can be selected as each R⁵ in the general formula (2) is an alkyl group having 1 to 10 carbon atoms. If the number of carbon atoms exceeds 10, a sufficiently high heat resistance cannot be achieved. In addition, the number of carbon atoms of the alkyl group which can be selected as each R⁵ is preferably 1 to 6, more preferably 1 to 5, and further preferably 1 to 4, and particularly preferably 1 to 3, from the viewpoint that the purification becomes easier. In addition, the alkyl group which can be selected as each R⁵ may be linear or branched. Further, the alkyl group is more preferably a methyl group or an ethyl group from the viewpoint of ease of purification.

R⁵s in the general formula (2) are each independently more preferably a hydrogen atom, a methyl group, an ethyl group, a n-propyl group, or an isopropyl group, and particularly preferably a hydrogen atom or a methyl group, for example, from the viewpoints that a higher heat resistance can be obtained when a polyimide is produced, that the raw materials are readily available, and that the purification is easier. In addition, the multiple R⁵s in the formula may be the same as one another or different from one another, and are preferably the same from the viewpoints of ease of purification and the like.

In addition, in the repeating unit represented by the general formula (2), R⁴ in the formula (2) is the same as R⁴ in the above-described general formula (1), and preferred ones thereof are also the same as those of R⁴ in the above-described general formula (1).

The repeating unit (B1) represented by the general formula (2) can be derived from a raw material compound (B) represented by the following general formula (201):

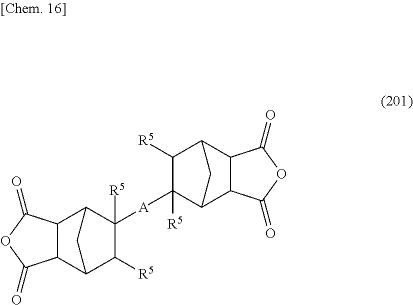

[in the formula (201), A has the same meaning as that of A in the general formula (2) (preferred ones thereof are also the same as those of A in the general formula (2)), multiple R⁵s each have the same meaning as that of R⁵s in the general formula (2) (preferred ones thereof are also the same as those of R⁵s in the general formula (2))], and an aromatic diamine represented by the above-described general formula (102). For example, the repeating unit (B1) represented by the general formula (2) can be contained in the polyimide by reacting the raw material compound (B) with the aromatic diamine (the above-described aromatic diamine represented by the general formula (102)) to form a polyamic acid comprising a repeating unit (B2) described later, followed by imidization of the polyamic acid. Note that specific reaction conditions, conditions which can be preferably employed for an imidization method, and the like are described later.

In addition, a method for producing the raw material compound (B) is not particularly limited, and a known method can be employed, as appropriate. For example, a method described in International Publication No. WO2015/163314 or the like may be employed.

<Repeating Unit (C1)>

The repeating unit (C1) which may be contained in the polyimide of the present invention is a repeating unit represented by the above-described general formula (3) (note that, in the above-described general formula (3), R⁴ represents an arylene group represented by the general formula (X), multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms).

The alkyl group which can be selected as each R⁶ in the general formula (3) is an alkyl group having 1 to 10 carbon atoms. If the number of carbon atoms exceeds 10, sufficiently high heat resistance cannot be achieved. In addition, the number of carbon atoms of the alkyl group which can be selected as each R⁶ is preferably 1 to 6, more preferably 1 to 5, further preferably 1 to 4, and particularly preferably 1 to 3, from the viewpoint that the purification becomes easier. In addition, the alkyl group which can be selected as each R⁶ may be linear or branched. Further, the alkyl group is more preferably a methyl group or an ethyl group from the viewpoint of ease of purification.

In addition, of the multiple R⁶ in the general formula (3), two R⁶s attached to the same carbon atom may together form a methylidene group (═CH₂). In other words, two R⁶s attached to the same carbon atom in the above-described general formula (3) may be together attached as a methylidene group (methylene group) through a double bond to the carbon atom (the carbon atom to which two R⁶s are attached among the carbon atoms forming each norbornane ring structure).

Multiple R⁶s in the general formula (3) are each independently more preferably a hydrogen atom, a methyl group, an ethyl group, a n-propyl group, or an isopropyl group, and particularly preferably a hydrogen atom or a methyl group, for example, from the viewpoints that a higher heat resistance can be obtained when a polyimide is produced, that the raw materials are easier to obtain (prepare), and that the purification is easier. In addition, multiple R⁶s in the formula may be the same as one another or different from one another, and are preferably the same from the viewpoints of ease of purification and the like.

In addition, R⁷ and R⁸ in the general formula (3) are each independently one selected from the group consisting of a hydrogen atom and alkyl groups having 1 to 10 carbon atoms. If the number of carbon atoms of the alkyl group which can be selected as any of R⁷ and R⁸ exceeds 10, the heat resistance of the polyimide is lowered. In addition, the alkyl group which can be selected as any of R⁷ and R⁸ is preferably 1 to 6, more preferably 1 to 5, further preferably 1 to 4, and particularly preferably 1 to 3, from the viewpoint that a higher heat resistance is obtained. In addition, the alkyl group which can be selected as any of R⁷ and R⁸ may be linear or branched.

In addition, R⁷ and R⁸ in the general formula (3) are each independently more preferably a hydrogen atom, a methyl group, an ethyl group, a n-propyl group, or an isopropyl group, and particularly preferably a hydrogen atom or a methyl group, for example, from the viewpoints that a higher heat resistance can be obtained when a polyimide is produced, that the raw material is readily available, and that the purification is easier. In addition, R⁷ and R⁸ in the formula (3) may be the same or different, and, are preferably the same from the viewpoints of ease of purification and the like.

In addition, multiple R⁶s, R⁷, and R⁸ in the general formula (3) are each particularly preferably a hydrogen atom. When each of the substituents represented by R⁶s, R⁷, and R⁸ in the repeating unit represented by the general formula (3) is a hydrogen atom, the yield of the compound tends to increase, and a higher heat resistance tends to be obtained.

In addition, in the repeating unit represented by the general formula (3), R⁴ in the formula (3) is the same as R⁴ in the above-described general formula (1), and preferred ones thereof are also the same as those of R⁴ in the above-described general formula (1).

The repeating unit (C1) represented by the general formula (3) can be derived from a raw material compound (C) represented by the following general formula (301):

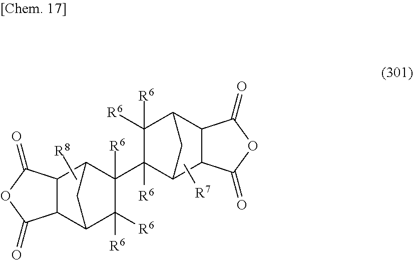

[in the formula (301), multiple R⁶s each have the same meaning as that of R⁶s in the general formula (3) (preferred ones thereof are also the same as those of R⁶s in the general formula (3)), and R⁷ and R⁸ have the same meaning as that of R⁷ or R⁸ in the general formula (3), respectively (preferred ones thereof are also the same as those of R⁷ and R⁸ in the general formula (3))] and an aromatic diamine represented by the above-described general formula (102). For example, the repeating unit (C1) represented by the general formula (3) can be contained in the polyimide by reacting the raw material compound (C) with an aromatic diamine (the above-described aromatic diamine represented by the general formula (102)) to form a polyamic acid comprising a repeating unit (C2) described later, followed by imidization of the polyamic acid. Note that specific reaction conditions, conditions which can be preferably employed for an imidization method, and the like are described later.

In addition, a method for producing the raw material compound (C) is not particularly limited, and, for example, a method (I) can be preferably employed which comprises:

a step (i) of reacting, in the presence of a palladium catalyst and an oxidizing agent, a norbornene-based compound represented by the following general formula (302):

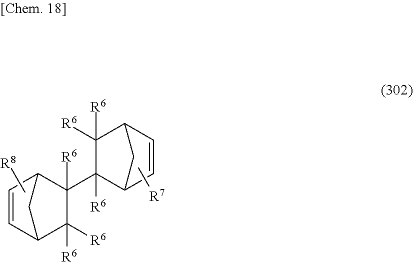

[in the formula (302), multiple R⁶s each have the same meaning as that of R⁶s in the general formula (3) (preferred ones thereof are also the same as those of R⁶s in the general formula (3)), R⁷ and R⁸ have the same meaning as that of R⁷ and R⁸ in the general formula (3), respectively (preferred ones thereof are also the same as those of R⁷ and R⁸ in the general formula (3))] with an alcohol and carbon monoxide to obtain a carbonyl compound represented by the following general formula (303):

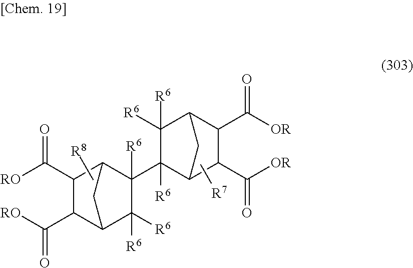

[in the formula (303), multiple R⁶s each have the same meaning as that of R⁶s in the general formula (3) (preferred ones thereof are also the same as those of R⁶s in the general formula (3)), R⁷ and R⁸ have the same meanings as that of R⁷ and R⁸ in the general formula (3), respectively (preferred ones thereof are also the same as those of R⁷ and R⁸ in the general formula (3)), and multiple Rs each independently represent one selected from the group consisting of a hydrogen atom, alkyl groups having 1 to 10 carbon atoms, cycloalkyl groups having 3 to 10 carbon atoms, alkenyl groups having 2 to 10 carbon atoms, aryl groups having 6 to 20 carbon atoms, and aralkyl groups having 7 to 20 carbon atoms]; and

a step (ii) of heating the carbonyl compound represented by the general formula (303) in a carboxylic acid having 1 to 5 carbon atoms while using an acid catalyst, to obtain the raw material compound (C). Hereinafter, the method (I) is described.

First, the step (i) of the method (I) is described. In the norbornene-based compound represented by the general formula (302) used in the step (i), R⁶s, R⁷, and R⁸ in the formula (302) are the same as R⁶s, R⁷, and R⁸ in the above-described general formula (3), respectively, and preferred ones thereof are also the same as those of R⁶s, R⁷ and R⁸ in the above-described general formula (3), respectively. Examples of the compound represented by the general formula (302) include 5,5′-bibicyclo[2.2.1]hept-2-ene (also referred to as 5,5′-bi-2-norbornene. (CAS No: 36806-67-4), 3-methyl-3′-methylene-2,2′-bis(bicyclo[2.2.1]heptene-5,5′-diene) (CAS No: 5212-61-3), 5,5′-bisbicyclo[2.2.1]hept-5-ene-2,2′-diol (CAS No: 15971-85-4), and the like. A method for producing the compound represented by the general formula (302) is not particularly limited, and a known method can be employed, as appropriate.

In addition, the alcohol used in the step (i) is not particularly limited, and, from the viewpoint of ease of purification, the alcohol is preferably an alcohol represented by the following general formula (304):

R^{a}OH (304)

[in the formula (304), R^{a} represents one selected from the group consisting of alkyl groups having 1 to 10 carbon atoms, cycloalkyl groups having 3 to 10 carbon atoms, alkenyl groups having 2 to 10 carbon atoms, aryl groups having 6 to 20 carbon atoms, and aralkyl groups having 7 to 20 carbon atoms (in other words, the same as the atoms and groups which can be selected as R in the general formula (303) except for hydrogen atom)].

In addition, the alkyl groups which can be selected as R^{a} in the general formula (304) are alkyl groups having 1 to 10 carbon atoms. If the number of carbon atoms of such an alkyl group exceeds 10, purification is difficult. In addition, the number of carbon atoms of each of the alkyl groups which can be selected as multiple R^{a}s is more preferably 1 to 5, and further preferably 1 to 3, from the viewpoint that the purification becomes easier. In addition, the alkyl groups which can be selected as multiple R^{a}s may be linear or branched.

In addition, the cycloalkyl groups which can be selected as R^{a} in the general formula (304) are cycloalkyl groups having 3 to 10 carbon atoms. If the number of carbon atoms of such a cycloalkyl group exceeds 10, purification is difficult. In addition, the number of carbon atoms of each of the cycloalkyl groups which can be selected as multiple R^{a}s is more preferably 3 to 8, and further preferably 5 to 6, from the viewpoint that the purification becomes easier.

Moreover, the alkenyl groups which can be selected as R^{a} in the general formula (304) are alkenyl groups having 2 to 10 carbon atoms. If the number of carbon atoms of such an alkenyl group exceeds 10, purification is difficult. In addition, the number of carbon atoms of each of the alkenyl groups which can be selected as multiple R^{a}s is more preferably 2 to 5, and further preferably 2 to 3, from the viewpoint that the purification becomes easier.

In addition, the aryl groups which can be selected as R^{a} in the general formula (304) are aryl groups having 6 to 20 carbon atoms. If the number of carbon atoms of such an aryl group exceeds 20, purification is difficult. In addition, the number of carbon atoms of each of the aryl groups which can be selected as multiple R^{a}s is more preferably 6 to 10, and further preferably 6 to 8, from the viewpoint that the purification becomes easier.

In addition, the aralkyl groups which can be selected as R^{a} in the general formula (304) are aralkyl groups having 7 to 20 carbon atoms. If the number of carbon atoms of such an aralkyl group exceeds 20, purification is difficult. In addition, the number of carbon atoms of each of the aralkyl groups which can be selected as multiple R^{a}s is more preferably 7 to 10, and further preferably 7 to 9, from the viewpoint that the purification becomes easier.

Moreover, multiple R^{a}s in the general formula (304) are each independently preferably a methyl group, an ethyl group, a n-propyl group, an isopropyl group, a n-butyl group, an isobutyl group, a sec-butyl, a t-butyl, a cyclohexyl group, an allyl group, a phenyl group, or a benzyl group, more preferably a methyl group, an ethyl group, or a n-propyl group, further preferably a methyl group or an ethyl group, and particularly preferably a methyl group, from the viewpoint that the purification becomes easier. Note that multiple R^{a}s in the general formula (304) may be the same as one another or different from one another, and are more preferably the same from the synthetic viewpoint.

Accordingly, as the alcohol represented by the general formula (304) used in the step (i), it is preferable to use an alkyl alcohol having 1 to 10 carbon atoms, a cycloalkyl alcohol having 3 to 10 carbon atoms, an alkenyl alcohol having 2 to 10 carbon atoms, an aryl alcohol having 6 to 20 carbon atoms, or an aralkyl alcohol having 7 to 20 carbon atoms.

Specific examples of the alcohols include methanol, ethanol, butanol, allyl alcohol, cyclohexanol, benzyl alcohol, and the like, of which methanol and ethanol are more preferable, and methanol is particularly preferable from the viewpoint that the purification of the compound to be obtained becomes easier. In addition, one of these alcohols may be used alone, or two or more thereof may be used as a mixture.

In addition, in the step (i), the norbornene-based compound represented by the general formula (302) is reacted with the alcohol (preferably R^{a}OH) and carbon monoxide (CO) in the presence of a palladium catalyst and an oxidizing agent. This makes it possible to introduce ester groups each represented by the following general formula (305):

—COOR^{a} (305)

[in the formula (305), R^{a} has the same meaning as that of R^{a} in the general formula (304) (preferred ones thereof are also the same)] to the olefinic carbons in the norbornene-based compound represented by the general formula (302) (R⁴s may be the same as one another or different from one another among the positions to which the ester groups are introduced). Thus, the carbonyl compound represented by the general formula (303) can be obtained.

As described above, the carbonyl compound represented by the general formula (303) is obtained in the step (i) by utilizing the reaction (hereinafter, this reaction is sometimes simply referred to as“esterification reaction”) by which ester groups are introduced to the olefinic carbons in the carbonyl compound by using an alcohol (preferably R^{a}OH) and carbon monoxide (CO) in the presence of a palladium catalyst and an oxidizing agent.

The palladium catalyst used in the esterification reaction is not particularly limited, and a known palladium-containing catalyst can be used, as appropriate. Examples thereof include inorganic acid salts of palladium, organic acid salts of palladium, catalysts in which palladium is supported on a support, and the like. In addition, preferred examples of the palladium catalyst include palladium chloride, palladium nitrate, palladium sulfate, palladium acetate, palladium propionate, palladium on carbon, palladium alumina, palladium black, palladium acetate having a nitrite ligand (formula: Pd₃(CH₃COO)₅(NO₂), and the like.

In addition, as the palladium catalyst used in the step (i) (the palladium catalyst used in the esterification reaction), it is preferable to use a palladium catalyst containing the palladium acetate having a nitrite ligand (the catalyst represented by the formula: Pd₃(CH₃COO)₅(NO₂)) (hereinafter, sometimes simply referred to as “Pd₃(OAc)₅(NO₂)”), for example, from the viewpoint that the formation of by-products can be suppressed more sufficiently, and the carbonyl compound represented by the general formula (303) can be produced with a higher selectivity.

In addition, in the palladium catalyst containing the palladium acetate having a nitrite ligand (Pd₃(OAc)₅(NO₂)), the amount of the palladium acetate having a nitrite ligand (Pd₃ (OAc)₅(NO₂)) contained is preferably 10% by mole or more in terms of metal (relative to the total amount of palladium in the palladium catalyst). If the content ratio of the palladium acetate having a nitrite ligand is less than the lower limit, it tends to be difficult to sufficiently suppress the formation of by-products, so that it tends to be difficult to produce the carbonyl compound represented by the general formula (303) with a sufficiently high selectivity. In addition, in the palladium catalyst, the content ratio of the palladium acetate having a nitrite ligand (Pd₃(OAc)₅(NO₂)) is more preferably 30% by mole or more, further preferably 40% by mole or more, particularly preferably 50% by mole or more, and most preferably 70% by mole to 100% by mole in terms of metal (relative to the total amount of palladium in the palladium catalyst), from the viewpoint that the formation of by-products can be suppressed at a higher level, and the ester compound can be produced with a higher selectivity.

In addition, when a palladium catalyst containing the palladium acetate having a nitrite ligand (Pd₃(OAc)₅(NO₂)) is used as the palladium catalyst used in the esterification reaction, other catalysts (other palladium catalyst components) which can be contained in addition to Pd₃(OAc)₅(NO₂) are not particularly limited, and it is possible to use, as appropriate, known palladium-based catalyst components which can be utilized for the reaction (esterification) of carbon monoxide and an alcohol at an olefin moiety (for example, palladium chloride, palladium nitrate, palladium sulfate, palladium acetate, palladium propionate, palladium on carbon, palladium alumina, palladium black, and the like).

Moreover, as the component (palladium-based catalyst component) which may be contained in the palladium catalyst in addition to the palladium acetate having a nitrite ligand, it is preferable to use palladium acetate from the viewpoints of suppression of the formation of by-products such as polymerization products and improvement in selectivity. More preferably, a mixed catalyst of the palladium acetate having a nitrite ligand (Pd₃(OAc)₅ (NO₂) and palladium acetate or a catalyst consisting of the palladium acetate having a nitrite ligand (Pd₃(OAc)₅ (NO₂) can be used as the palladium catalyst from the viewpoints of suppression of the formation of by-products such as polymerization products and improvement in selectivity.

Note that a method for producing the palladium acetate having a nitrite ligand (Pd₃(OAc)₅(NO₂)) is not particularly limited, and a known method can be used, as appropriate. For example, it is possible to use, as appropriate, the method described on Pages 1989 to 1992 of Dalton Trans (vol. 11) published on Jun. 7, 2005 (authors: Vladimir I, Bakhmutov, et al.), or the like.

Meanwhile, the oxidizing agent used in the step (i) (the oxidizing agent used in the esterification reaction) may be any, as long as when Pd²⁺ in the palladium catalyst is reduced to Pd⁰ during the esterification reaction, the oxidizing agent can oxidize the Pd⁰ to Pd²⁺. The oxidizing agent is not particularly limited, and examples thereof include copper compounds, iron compounds, and the like. In addition, specific examples of the oxidizing agents include copper(II) chloride, copper(II) nitrate, copper(II) sulfate, copper(II) acetate, iron(III) chloride, iron(III) nitrate, iron(III) sulfate, iron(III) acetate, and the like.

Moreover, the amount of the alcohol used in the step (i) (in the esterification reaction) is not particularly limited, as long as the compound represented by the general formula (303) can be obtained with that amount. For example, the alcohol may be added in an amount greater than or equal to the amount (theoretical amount) theoretically necessary to obtain the compound represented by the general formula (303), and the excessive alcohol, as it is, may be used as a solvent.

In addition, in the step (i) (in the esterification reaction), the carbon monoxide only needs to be supplied in a necessary amount to the reaction system. For this reason, it is not necessary to use high-purity carbon monoxide gas as the carbon monoxide, and a mixture gas obtained by mixing a gas inactive in the esterification reaction (for example, nitrogen) with carbon monoxide may be used. In addition, the pressure of carbon monoxide is not particularly limited, and is preferably normal pressure (approximately 0.1 MPa [1 atm]) or higher and 10 MPa or lower. Moreover, a method for supplying the carbon monoxide to the reaction system is not particularly limited, and a known method can be employed, as appropriate. For example, it is possible to employ, as appropriate, a method in which carbon monoxide is supplied by bubbling into a mixture liquid containing the alcohol, the compound represented by the general formula (302), and the palladium catalyst, a method in which, in a case of using a reaction vessel, carbon monoxide is supplied to the reaction system by introducing carbon monoxide into the atmospheric gas in the vessel, or the like.

In addition, when carbon monoxide is supplied into in a mixture liquid containing the alcohol, the compound represented by the general formula (302), and the palladium catalyst, the carbon monoxide is preferably supplied at a ratio (supply rate) of 0.002 to 0.2 mole equivalent/min (more preferably 0.005 to 0.1 mole equivalent/min, further preferably 0.005 to 0.05 mole equivalent/min) relative to the compound represented by the general formula (302). If the supply ratio of carbon monoxide is lower than the lower limit, the reaction rate tends to be slow, and by-products such as polymerization products tend to be easily formed. Meanwhile, if the supply ratio of carbon monoxide exceeds the upper limit, the reaction rate tends to increase, and the reaction tends to proceed at once, so that it tends to be difficult to control the reaction. Note that, theoretically, 4 mole equivalents of carbon monoxide reacts with 1 mole of the compound represented by the general formula (302) serving as a raw material, and hence, for example, when the ratio (supply rate) is 0.1 mole equivalent/min, 40 minutes (4 [mole equivalents]/0.1 [mole equivalent/min]=40 minutes) is necessary to introduce 4 mole equivalents, which is the theoretical amount, to 1 mole of the compound represented by the general formula (302). In addition, as a method for supplying carbon monoxide at such a supply rate, it is preferable to employ a method in which carbon monoxide is supplied by bubbling into a mixture liquid containing the alcohol, the compound represented by the general formula (302), and the palladium catalyst.

In addition, when the carbon monoxide is supplied by bubbling, a specific method for the bubbling is not particularly limited, and a known bubbling method can be employed, as appropriate. For example, a so-called bubbling nozzle, a tube provided with many holes, or the like may be used, as appropriate, to supply the carbon monoxide into the mixture liquid by bubbling.

Moreover, a method for controlling the supply rate of the carbon monoxide is not particularly limited, and a known controlling method may be employed, as appropriate. For example, when carbon monoxide is supplied by bubbling, a method may be employed in which the supply rate of the carbon monoxide is controlled at the above-described ratio by using a known device capable of supplying a gas at a specific ratio to the bubbling nozzle, the tube provided with many holes, or the like. In addition, when carbon monoxide is supplied by bubbling and when a reaction vessel is used, it is preferable to adjust the position of the bubbling nozzle, the tube, or the like near a bottom portion of the vessel. This is intended to facilitate the contact between the compound represented by the general formula (302) present in the bottom portion and the carbon monoxide supplied through the bubbling nozzle or the like.

In addition, in the esterification reaction, the amount of the palladium catalyst used is preferably such that the amount of moles of palladium in the palladium catalyst is 0.001 to 0.1 times (more preferably 0.001 to 0.01 times) that of the norbornene-based compound represented by the general formula (302). If the amount of the palladium catalyst used is less than the lower limit, the lowered reaction rate tends to lower the yield. Meanwhile, if the amount of the palladium catalyst used exceeds the upper limit, it tends to be difficult to remove palladium from the product, so that the purity of the product tends to be lowered.

In addition, the amount of the oxidizing agent used is preferably such that the amount of moles of the oxidizing agent is 2 to 16 times (more preferably 2 to 8 times and further preferably 2 to 6 times) that of the norbornene-based compound represented by the general formula (302). If the amount of the oxidizing agent used is less than the lower limit, the oxidation reaction of palladium cannot be promoted sufficiently, so that large amounts of by-products tend to be formed. Meanwhile, if the amount of the oxidizing agent used exceeds the upper limit, the purification tends to be difficult, and the purity of the product tends to be lowered.

In addition, a solvent may be used for the reaction (esterification reaction) of the norbornene-based compound represented by the general formula (302) with an alcohol and carbon monoxide. The solvent is not particularly limited, and a known solvent which can be used for esterification reaction can be used, as appropriate. Examples thereof include hydrocarbon-based solvents such as n-hexane, cyclohexane, benzene, and toluene.

Moreover, an acid is by-produced from the oxidizing agent or the like in the esterification reaction. To remove the acid, a base may be added. The base is preferably a fatty acid salt such as sodium acetate, sodium propionate, or sodium butyrate. In addition, the amount of the base used only needs to be adjusted, as appropriate, according to the amount of the acid generated and the like.

In addition, a reaction temperature condition for the esterification reaction is not particularly limited, and is preferably 0° C. to 200° C. [more preferably 0° C. to 100° C., further preferably about 10 to 60° C., and particularly preferably a temperature of about 20 to 50° C.]. If the reaction temperature exceeds the upper limit, the yield tends to decrease. Meanwhile, if the reaction temperature is lower than the lower limit, the reaction rate tends to be lowered. In addition, the reaction time of the esterification reaction is not particularly limited, and is preferably about 30 minutes to 24 hours.

In addition, an atmospheric gas for the esterification reaction is not particularly limited, and a gas which can be used for esterification reaction can be used, as appropriate. For example, the atmospheric gas may be a gas inactive in the esterification reaction (nitrogen, argon, or the like), carbon monoxide, or a mixture gas of carbon monoxide and another gas (nitrogen, air, oxygen, hydrogen, carbon dioxide, argon, or the like). From the viewpoint that no influence is exerted on the catalyst or the oxidizing agent, the atmospheric gas is preferably carbon monoxide, a gas inactive in the esterification reaction, or a mixture gas of carbon monoxide and a gas inactive in the esterification reaction. Note that when a method in which carbon monoxide is introduced by bubbling is employed as a method for supplying carbon monoxide into the mixture liquid, the reaction may be caused to proceed, for example, as follows. Specifically, a gas inactive in the esterification reaction is employed as the atmospheric gas before the reaction, and the reaction is started by the above-described bubbling, so that the atmospheric gas becomes a mixture gas of carbon monoxide and the gas inactive in the esterification reaction.

Moreover, a pressure condition (pressure condition of atmospheric gas: when the reaction is caused to proceed in a reaction vessel, the pressure condition of the gas in the vessel) for the esterification reaction is not particularly limited, and is preferably 0.05 MPa to 15 MPa, more preferably normal pressure (0.1 MPa [1 atm]) to 15 MPa, further preferably 0.1 MPa to 10 MPa, and particularly preferably 0.11 MPa to 5 MPa. If the pressure condition is lower than the lower limit, the reaction rate tends to be lowered, and the yield of the target product tends to decrease. Meanwhile, if the pressure condition is higher than the upper limit, the reaction rate tends to increase, and the reaction tends to proceed at once, so that it tends to be difficult to control the reaction, and facilities in which the reaction can be conducted tend to be limited.

Causing the esterification reaction to proceed as described above makes it possible to obtain a carbonyl compound (tetraester compound) represented by the general formula (303) in which each R in the formula (303) is a group other than a hydrogen atom. In addition, when a carbonyl compound represented by the general formula (303) in which each R in the formula (303) is a hydrogen atom is produced, a hydrolysis treatment or a transesterification reaction with a carboxylic acid may be conducted after the introduction of the groups represented by the above-described formula: —COOR^{a} by the esterification reaction in order to convert these groups into the groups represented by the formula: —COOH in which R^{a} is a hydrogen atom. A method for the reaction is not particularly limited, and a known method capable of converting a group (ester group) represented by the formula: —COOR^{a} into the formula: —COOH (carboxy group) can be employed, as appropriate.

Thus, the carbonyl compound represented by the general formula (303) can be obtained. Note that multiple R⁶s in the general formula (303) each have the same meaning as that of R⁶s in the general formula (3), and preferred ones thereof are also the same as those of R⁶s in the general formula (3). In addition, R⁷ and R⁸ in the general formula (303) have the same meanings as those of R⁷ and R⁸ in the general formula (3), respectively, and preferred ones thereof are also the same as those of R⁷ and R⁸ in the general formula (3).

Moreover, multiple Rs in the general formula (303) are each independently one selected from the group consisting of a hydrogen atom, alkyl groups having 1 to 10 carbon atoms, cycloalkyl groups having 3 to 10 carbon atoms, alkenyl groups having 2 to 10 carbon atoms, aryl groups having 6 to 20 carbon atoms, and aralkyl groups having 7 to 20 carbon atoms. The alkyl groups having 1 to 10 carbon atoms, the cycloalkyl groups having 3 to 10 carbon atoms, the alkenyl groups having 2 to 10 carbon atoms, the aryl groups having 6 to 20 carbon atoms, and the aralkyl groups having 7 to 20 carbon atoms which can be selected as Rs are respectively the same as those described as the alkyl groups having 1 to 10 carbon atoms, the cycloalkyl groups having 3 to 10 carbon atoms, the alkenyl groups having 2 to 10 carbon atoms, the aryl groups having 6 to 20 carbon atoms, and the aralkyl groups having 7 to 20 carbon atoms which can be selected as R^{a} in the general formula (304) (preferred ones thereof are also the same).

Note that multiple Rs in the general formula (303) are each independently preferably a methyl group, an ethyl group, a n-propyl group, an isopropyl group, a n-butyl group, an isobutyl group, a sec-butyl, a t-butyl, a cyclohexyl group, an allyl group, a phenyl group, or a benzyl group, more preferably a methyl group, an ethyl group, or a n-propyl group, further preferably a methyl group or an ethyl group, and particularly preferably a methyl group, from the viewpoint that the purification becomes easier. Note that multiple R⁴ in the general formula (2) may be the same as one another or different from one another, and are more preferably the same from the synthetic viewpoint.

Next, the step (ii) of the method (I) is described. The step (ii) is a step of heating the carbonyl compound represented by the general formula (303) in a carboxylic acid having 1 to 5 carbon atoms while using an acid catalyst, to obtain the raw material compound (C).

The acid catalyst used in the step (ii) may be a homogeneous acid catalyst or a heterogeneous acid catalyst (solid catalyst), and is not particularly limited. The acid catalyst is preferably a homogeneous acid catalyst from the viewpoint of ease of purification. In addition, the homogeneous acid catalyst is not particularly limited, and it is possible to use, as appropriate, a known homogeneous acid catalyst which can be used for a reaction by which a carboxylic acid is converted to an anhydride or a reaction by which an ester compound is converted to an acid anhydride. Examples of the homogeneous acid catalyst include trifluoromethanesulfonic acid, tetrafluoroethanesulfonic acid, pentafluoroethanesulfonic acid, heptafluoropropanesulfonic acid, heptafluoroisopropanesulfonic acid, nonafluorobutanesulfonic acid, heptafluorodecanesulfonic acid, bis(nonafluorobutanesulfonyl)imide, N,N-bis(trifluoromethanesulfonyl)imide, and chlorodifluoroacetic acid.

In addition, from the viewpoint of improvement in reaction yield, the homogeneous acid catalyst is more preferably trifluoromethanesulfonic acid, tetrafluoroethanesulfonic acid, nonafluorobutanesulfonic acid, or chlorodifluoroacetic acid, and further preferably trifluoromethanesulfonic acid or tetrafluoroethanesulfonic acid. Note that one of these homogeneous acid catalysts may be used alone, or two or more thereof may be used in combination.

In addition, the amount of the acid catalyst (more preferably the homogeneous acid catalyst) used in the step (ii) is not particularly limited, and is preferably such that the acid amount of moles of the homogeneous acid catalyst is 0.001 to 2.00 mole equivalents (more preferably 0.01 to 1.00 mole equivalents) to the amount (the amount of moles) of the carbonyl compound (the raw material compound of the tetracarboxylic dianhydride) represented by the general formula (303) used. If the amount of the acid catalyst used is less than the lower limit, the reaction rate tends to be lowered. Meanwhile, if the amount of the acid catalyst used exceeds the upper limit, the purity of the product tends to be lowered because the purification is slightly difficult. Note that the acid amount of moles of the acid catalyst herein is the amount of moles in terms of functional groups (for example, sulfonic acid groups (sulfo groups), carboxylic acid groups (carboxy groups) or the like) in the acid catalyst.

Moreover, the amount of the acid catalyst (more preferably the homogeneous acid catalyst) used in the step (ii) is preferably 0.1 to 100 parts by mass, and more preferably 1 to 20 parts by mass relative to 100 parts by mass of the carbonyl compound represented by the general formula (303). If the amount of the acid catalyst used is less than the lower limit, the reaction rate tends to be lowered. Meanwhile, if the amount of the acid catalyst used exceeds the upper limit, side reaction products tend to be formed more easily.

Moreover, the carboxylic acid having 1 to 5 carbon atoms (hereinafter, sometimes simply referred to as “lower carboxylic acid”) is used in the step (ii). If the number of carbon atoms of the lower carboxylic acid exceeds the upper limit, the production and purification are difficult. In addition, examples of the lower carboxylic acid include formic acid, acetic acid, propionic acid, butyric acid, and the like, of which formic acid, acetic acid, and propionic acid are preferable, and formic acid and acetic acid are more preferable from the viewpoint of ease of the production and purification. One of these lower carboxylic acids may be used alone, or two or more thereof may be used in combination.

In addition, the amount of the lower carboxylic acid (for example, formic acid, acetic acid, or propionic acid) used is not particularly limited, and is preferably such that the amount of moles of the lower carboxylic acid is 4 to 100 times the amount of moles of the carbonyl compound represented by the general formula (303). If the amount of the lower carboxylic acid (formic acid, acetic acid, propionic acid, or the like) used is less than the lower limit, the yield tends to decrease. Meanwhile, if the amount of the lower carboxylic acid exceeds the upper limit, the reaction rate tends to be lowered.

In addition, since the carbonyl compound is heated in the lower carboxylic acid in the step (ii), the carbonyl compound is preferably contained in the lower carboxylic acid. The amount of the carbonyl compound represented by the general formula (303) contained in the lower carboxylic acid is preferably 1 to 40% by mass, and more preferably 2 to 30% by mass. If the amount of the carbonyl compound contained is less than the lower limit, the yield tends to decrease. Meanwhile, if the amount of the carbonyl compound contained exceeds the upper limit, the reaction rate tends to be lowered.

Hereinabove, the carbonyl compound represented by the general formula (303), the acid catalyst, and the carboxylic acid having 1 to 5 carbon atoms used in the step (ii) are described. Next, a heating step using them (a step of heating the carbonyl compound in the carboxylic acid having 1 to 5 carbon atoms while using the acid catalyst) is described.

Note that, in the step (ii), when the carbonyl compound is a compound (tetracarboxylic acid) represented by the general formula (303) in which Rs are each a hydrogen atom, a reaction (forward reaction) in which a tetracarboxylic dianhydride and water are formed from the carbonyl compound (tetracarboxylic acid) proceeds in the above-described heating step. In addition, the forward reaction and a reverse reaction in which the carbonyl compound (tetracarboxylic acid) is formed from the tetracarboxylic dianhydride and water are an equilibrium reaction. Moreover, when the carbonyl compound is a compound represented by the general formula (303) in which Rs are each a group other than a hydrogen atom in the present invention, a reaction (forward reaction) in which the tetracarboxylic dianhydride, the ester compound of the lower carboxylic acid, and water are formed from the carbonyl compound and the lower carboxylic acid proceeds in the heating step. In addition, the forward reaction and a reverse reaction in which the carbonyl compound and the lower carboxylic acid are formed from the carboxylic anhydride, the ester compound of the lower carboxylic acid, and water is an equilibrium reaction. For this reason, in the heating step, it is also possible to cause the reaction (forward reaction) to proceed efficiently by changing, as appropriate, the concentrations of the components in the system and the like.

In addition, conditions (including conditions of heating temperature and atmosphere, and the like) which can be employed in the heating step are not particularly limited, and any conditions may be employed, as appropriate, as long as ester groups and/or carboxy groups (carboxylic acid groups) in the carbonyl compound can be converted to an acid anhydride group by heating the carbonyl compound in the lower carboxylic acid while using the acid catalyst by the method (under the conditions). For example, conditions as employed for a known reaction by which an acid anhydride group can be formed can be used, as appropriate.

In addition, for the heating step, it is preferable to first prepare a mixture of the lower carboxylic acid, the carbonyl compound, and the acid catalyst, so that heating in the lower carboxylic acid can be conducted. A method for preparing the mixture is not particularly limited, and the mixture may be prepared, as appropriate, according to an apparatus used in the heating step and the like. For example, the mixture may be prepared by adding (introducing) them into a single container.

In addition, in this heating step, another solvent may be further used by being added to the lower carboxylic acid. Examples of the solvent (another solvent) include aromatic solvents such as benzene, toluene, xylene, and chlorobenzene; ether-based solvent such as ether, THF, and dioxane; ester-based solvents such as ethyl acetate; hydrocarbon-based solvents such as hexane, cyclohexane, heptane, and pentane; nitrile-based solvents such as acetonitrile and benzonitrile; halogen-containing solvents such as methylene chloride and chloroform; ketone-based solvents such as acetone and MEK; and amide-based solvents such as DMF, NMP, DMI, and DMAc.

In addition, the temperature condition under which the carbonyl compound represented by the general formula (303) is heated in the lower carboxylic acid is not particularly limited, and the upper limit of the heating temperature is preferably 180° C. (more preferably 150° C., further preferably 140° C., and particularly preferably 130° C.), while the lower limit of the heating temperature is preferably 80° C. (more preferably 100° C., and further preferably 110° C.). The temperature range (temperature condition) for the heating is preferably 80 to 180° C., more preferably 80 to 150° C., further preferably 100 to 140° C., and particularly preferably 110 to 130° C. If the temperature condition is lower than the lower limit, the reaction tends to proceed so insufficiently that the target tetracarboxylic dianhydride cannot be produced sufficiently efficiently. Meanwhile, if the temperature condition exceeds the upper limit, the catalytic activity tends to be lowered. In addition, the heating temperature is preferably set to a temperature lower than the boiling point of the homogeneous acid catalyst within the above-described range of the temperature condition. By setting the heating temperature as described above, the product can be obtained more efficiently.

In addition, the heating step may comprise a step of refluxing the mixture (a mixture of the lower carboxylic acid, the carbonyl compound, and the acid catalyst) by heating, for example, from the viewpoint of forming the carboxylic anhydride more efficiently. As described above, when the heating step comprises the reflux step, the carboxylic anhydride can be produced more efficiently. In other words, since the reaction does not proceed sufficiently at an initial stage of the heating in the heating step, almost no by-products such as water are formed. Accordingly, even though distilled components (vapor) are not removed, the forward reaction by which the carboxylic dianhydride is produced can be caused to proceed efficiently without receiving a great influence from by-products (such as water) for a period before the reaction proceeds to some degree (at an initial stage of the heating).

For this reason, especially, at an initial stage of the heating, the refluxing makes it possible to cause the forward reaction to proceed efficiently by utilizing more efficiently the lower carboxylic acid. This makes it possible to form the carboxylic an hydride more efficiently.

Here, the degree of the progress of the forward reaction can be determined by checking the amounts of by-products (for example, water and the ester compound of the lower carboxylic acid) contained in the vapor or the like. For this reason, when the reflux step is performed, the reflux time may be set, as appropriate, while checking the amount of a by-product (for example, the ester compound of the lower carboxylic acid) in the vapor or the like so that the reaction can proceed efficiently, and then a step of removing distilled components may be performed under heating. By performing the step of removing distilled components as described above, by-products (for example, the ester compound of the lower carboxylic acid and water) can be removed from the reaction system, and the forward reaction can be caused to proceed more efficiently. In addition, in the step of removing distilled components, there is a case where the amount of the lower carboxylic acid is reduced when the distilled component (vapor) are removed by distillation, as appropriate (for example, a case where the carboxylic acid is consumed by the formation of the ester compound of the lower carboxylic acid and water are formed as the by-products, and the removal of the vapor by distillation results in the reduction in the amount of the carboxylic acid or the like). In such a case, the heating is preferably conducted, while the lower carboxylic acid in an amount equivalent to the reduced amount is being added, as appropriate (added continuously in some cases). The addition of the lower carboxylic acid as described above (continuous addition in some cases) makes it possible to cause the forward reaction to proceed further efficiently, for example, in a case where the carbonyl compound is a compound represented by the general formula (303) in which R⁴s are each a group other than a hydrogen atom, or the like.

In addition, when the heating step comprises the step of refluxing the mixture, the reflux conditions are not particularly limited, and known conditions can be employed, as appropriate. The conditions may be changed, as appropriate, to preferred ones according to the type of the carbonyl compound used and the like.

In addition, the pressure condition under which the carbonyl compound represented by the general formula (303) is heated in the lower carboxylic acid (the pressure condition during the reaction) is not particularly limited. The condition may be normal pressure, a pressurized condition, or a reduced pressure condition, and the reaction can be caused to proceed under any one of these conditions. For this reason, when, for example, the above-described reflux step is employed without particularly controlling the pressure in the heating step, the reaction may be conducted under a condition pressurized by the vapor of the lower carboxylic acid serving as the solvent, or the like. In addition, the pressure condition is preferably 0.001 to 10 MPa, and further preferably 0.1 to 1.0 MPa. If the pressure condition is lower than the lower limit, the lower carboxylic acid tends to be gasified. Meanwhile, if the pressure condition exceeds the upper limit, the ester compound of the lower carboxylic acid formed in the reaction by heating tends not to evaporate, so that it is difficult to cause the forward reaction to proceed.

In addition, an atmospheric gas in which the carbonyl compound represented by the general formula (303) is heated in the lower carboxylic acid is not particularly limited, and may be, for example, air or an inert gas (nitrogen, argon, or the like). Note that, to cause the reaction to proceed more efficiently (to shift the transesterification equilibrium reaction further to the product side) by efficiently evaporating the by-products (the ester compound of the lower carboxylic acid and water) formed in the reaction, the above-described gas (desirably an inert gas such as nitrogen or argon) may be bubbled, or stirring may be conducted, while the gas is being passed through the gas phase portion of a reactor (reaction vessel).

In addition, the heating time for which the carbonyl compound represented by the general formula (303) is heated in the lower carboxylic acid is not particularly limited, and is preferably 0.5 to 100 hours, and more preferably 1 to 50 hours. If the heating time is less than the lower limit, the reaction tends to proceed so insufficiently that a sufficient amount of the carboxylic anhydride cannot be produced. Meanwhile, if the heating time exceeds the upper limit, the reaction tends not to proceed any further, so that the production efficiency is lowered, and the economical efficiency and the like are lowered.

In addition, when the carbonyl compound represented by the general formula (303) is heated in the lower carboxylic acid, the reaction may be caused to proceed, while the lower carboxylic acid into which the carbonyl compound is introduced (more preferably a mixture of the lower carboxylic acid, the carbonyl compound, and the acid catalyst) is being stirred from the viewpoint that the reaction is caused to proceed uniformly.

Moreover, in the step (heating step) of heating the carbonyl compound represented by general formula (303) in the lower carboxylic acid, acetic anhydride is preferably used together with the lower carboxylic acid. In other words, in the present invention, it is preferable to use acetic anhydride during the heating. The use of acetic anhydride as described above makes it possible to form acetic acid by a reaction of water formed during the reaction with acetic anhydride. This makes it possible to remove water formed during the reaction efficiently, so that the forward reaction can be caused to proceed more efficiently. In addition, when acetic anhydride is used as described above, the amount of the acetic anhydride used is not particularly limited, and is preferably such that the amount of moles of the acetic anhydride used is 4 to 100 times that of the carbonyl compound represented by the general formula (303). If the amount of the acetic anhydride used is less than the lower limit, the reaction rate tends to be lowered. Meanwhile, if the amount of the acetic anhydride used exceeds the upper limit, the yield tends to decrease.

In addition, also when acetic anhydride is used as described above, the conditions described for the heating step above are preferably employed as a temperature condition, a pressure condition, an atmospheric gas condition, a heating time condition, and the like during the heating. In addition, when acetic anhydride is used as described above, acetic acid can be formed by a reaction of water formed during the reaction with acetic anhydride. This not only makes it possible to efficiently remove water formed during the reaction without conducting the removal of the vapor by distillation or the like, but also leads to a more efficient progress of the reaction (forward reaction) in which acetic acid is formed from acetic anhydride and water and the tetracarboxylic dianhydride is formed. For this reason, when acetic anhydride is used as described above, the reaction can be caused to proceed efficiently by employing the reflux step in the heating step. From such a view point, the heating step is preferably a step of refluxing the mixture, when acetic anhydride is used. When reflux is conducted while using acetic anhydride as described above, it is also possible to cause the reaction to proceed sufficiently only by conducting the reflux step without conducting a step of removing the vapor by distillation or a step of adding a lower carboxylic acid according to the amount of the acetic anhydride used or the like, and it is also possible to produce the tetracarboxylic dianhydride more efficiently.

In the step (ii), the tetracarboxylic dianhydride represented by the general formula (301) can be obtained efficiently from the carbonyl compound represented by the general formula (303) by conducting the heating step as described above.

<Polyimide>

A polyimide of the present invention comprises at least one repeating unit selected from the group consisting of the repeating unit (A1), the repeating unit (B1), and the repeating unit (C1) as described above.

In the polyimide of the present invention, the total amount (sum) of the repeating unit (A1), the repeating unit (B1), and the repeating unit (C1) is preferably 30 to 100% by mole (further preferably 40 to 100% by mole, more preferably 50 to 100% by mole, further preferably 70 to 100% by mole, particularly preferably 80 to 100% by mole, and most preferably 90 to 100% by mole) relative to all repeating units. If the total amount (sum) of the repeating unit (A1), the repeating unit (B1), and the repeating unit (C1) is less than the lower limit, it tends to be difficult to obtain a higher level of heat resistance based on the glass transition temperature (Tg).

In addition, the polyimide may comprise an additional repeating unit within a range not impairing an effect of the present invention. The additional repeating unit is not particularly limited, and examples thereof include known repeating units which can be used as repeating units of polyimides, and the like.

In addition, the additional repeating unit is preferably at least one selected from the group consisting of a repeating unit (A′) represented by the general formula (1) in which R⁴ is an arylene group having 6 to 40 carbon atoms and being other than the arylene group represented by the general formula (X), a repeating unit (B′) represented by the general formula (2) in which R⁴ is an arylene group having 6 to 40 carbon atoms and being other than the arylene group represented by the general formula (X), and a repeating unit (C′) represented by the general formula (3) in which R⁴ is an arylene group having 6 to 40 carbon atoms and being other than the arylene group represented by the general formula (X).

In each of the repeating unit (A′), the repeating unit (B′), and the repeating unit (C′), the group represented by R⁴ in the corresponding one of the general formulae (1) to (3) is an arylene group having 6 to 40 carbon atoms and being other than the arylene group represented by the general formula (X). The number of carbon atoms of the arylene group in each of the repeating unit (A′), the repeating unit (B′), and the repeating unit (C′) is preferably 6 to 30, and more preferably 12 to 20. If the number of carbon atoms is less than the lower limit, the heat resistance of the polyimide tends to be lowered when such an additional repeating unit is contained. Meanwhile, if the number of carbon atoms exceeds the upper limit, the solubility in solvent of a polyimide obtained when such an additional repeating unit is contained tends to decrease, so that the formability into a film or the like tends to be lowered.

In addition, from the viewpoint of the balance between heat resistance and solubility, R⁴ in each of the general formulae (1) to (3) of the repeating unit (A′), the repeating unit (B′), and the repeating unit (C′) is preferably at least one of the groups represented by the following general formula (7) to (10):

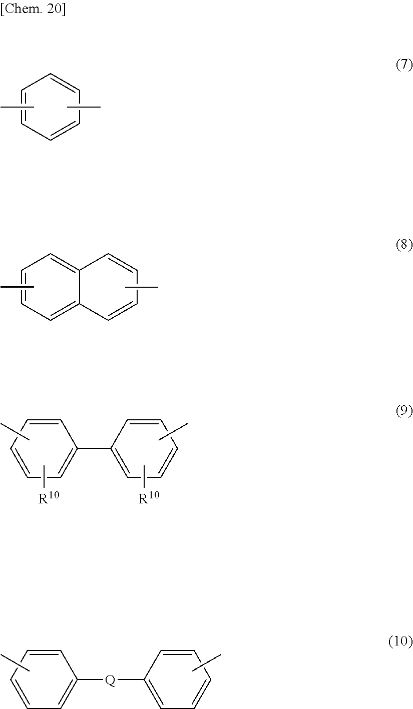

[in the formula (9), each R¹⁰ represents one selected from the group consisting of a hydrogen atom, a fluorine atom, a methyl group, an ethyl group, and a trifluoromethyl group, and in the formula (10), Q represents one selected from the group consisting of the groups represented by the formulae: —C₆H₄—, —CONH—C₆H₄—NHCO—, —NHCO—C₆H₄—CONH—, —O—C₆H₄—CO—C₆H₄—O—, —OCO—C₆H₄—COO—, —OCO—C₆H₄—C₆H₄—COO—, —OCO—, —NC₆H₅—, —CO—C₄H₈N₂—CO—, —C₁₃H₁₀—, —(CH₂)—, —O—, —S—, —CO—, —CONH—, —SO₂—, —C(CF₃)₂—, —C(CH₃)₂—, —CH₂—, —(CH₂)₂—, —(CH₂)₃—, —(CH₂)₄, —(CH₂)₅—, —O—C₆H₄—C(CH₃)₂—C₆H₄—O—, —O—C₆H₄—C(CF₃)₂—C₆H₄—O—, —O—C₆H₄—SO₂—C₆H₄—O—, —C(CH₃)₂—C₆H₄—C(CH₃)₂—, —O—C₆H₄—C₆H₄—O—, and —O—C₆H₄—O—].

Each R¹⁰ in the general formula (9) is more preferably a hydrogen atom, a fluorine atom, a methyl group, or an ethyl group, and particularly preferably a hydrogen atom from the viewpoint of the heat resistance of a polyimide obtained. Meanwhile, Q in the general formula (10) is more preferably a group represented by the formula: —CONH—, —O—C₆H₄—O—, —O—C₆H₄—C₆H₄—O—, —O—, or —O—C₆H₄—SO₂—C₆H₄—O—, and particularly preferably a group represented by —O— or —O—C₆H₄—SO₂—C₆H₄—O— from the viewpoint of the balance between heat resistance and solubility.

In addition, the repeating unit (A′) can be derived from the above-described raw material compound (A) and an aromatic diamine represented by the following general formula (103):

[Chem. 21]

H₂N—R⁴—NH₂ (103)

[in the formula (103), R⁴ represents an arylene group having 6 to 40 carbon atoms and being other than the arylene group represented by the general formula (X)]. In other words, the repeating unit (A′) can be contained in the polyimide by reacting the raw material compound (A) with an aromatic diamine of the above-described general formula (103) in which R⁴ is an arylene group having 6 to 40 carbon atoms and being other than the arylene group represented by the general formula (X). Likewise, the repeating unit (B′) can be contained in the polyimide by reacting the raw material compound (B) with an aromatic diamine of the above-described general formula (103) in which R⁴ is an arylene group having 6 to 40 carbon atoms and being other than the arylene group represented by the general formula (X). Moreover, the repeating unit (C′) can be contained in the polyimide by reacting the raw material compound (C) with an aromatic diamine of the above-described general formula (103) in which R⁴ is an arylene group having 6 to 40 carbon atoms and being other than the arylene group represented by the general formula (X).

In addition, the polyimide has a glass transition temperature (Tg) of preferably 340° C. or higher, more preferably 350 to 550° C., and further preferably 400 to 550° C. If the glass transition temperature (Tg) is lower than the lower limit, it tends to be difficult to achieve a high level of heat resistance as required in the present application. Meanwhile, if the glass transition temperature (Tg) is higher than the upper limit, it tends to be difficult to produce a polyimide having such a property. Note that the glass transition temperature (Tg) can be determined by using a thermomechanical analyzer (manufactured by Rigaku Corporation under the trade name of “TMA8310”) in a tensile mode. Specifically, a polyimide film having a size of 20 mm in length and 5 mm in width (the thickness of the film is not particularly limited because it does not exert any influence on the measured value, and is preferably 5 to 80 μm) is formed as a measurement sample, and measured under a nitrogen atmosphere by employing the conditions of a tensile mode (49 mN) and a rate of temperature rise of 5° C./min. Then, a curve before and after an inflection point of a TMA curve attributable to the glass transition is extrapolated. Thus, the glass transition temperature (Tg) can be determined.

The polyimide of the present invention has a 5% weight-loss temperature of preferably 400° C. or higher, and more preferably 450 to 550° C. If the 5% weight-loss temperature is lower than the lower limit, it tends to be difficult to achieve a sufficient heat resistance. Meanwhile, if the 5% weight-loss temperature exceeds the upper limit, it tends to be difficult to produce a polyimide having such a property. Note that the 5% weight-loss temperature can be determined under a nitrogen gas atmosphere in a nitrogen gas stream by raising the temperature from room temperature (for example, 25° C.) to 40° C., then gradually heating a sample from 40° C., which is a measurement-starting temperature, and measuring the temperature at which the weight loss of the sample used reaches 5%.

Moreover, the polyimide has a softening temperature of preferably 300° C. or higher, and more preferably 350 to 550° C. If the softening temperature is lower than the lower limit, it tends to be difficult to achieve a sufficient heat resistance. Meanwhile, if the softening temperature exceeds the upper limit, it tends to be difficult to produce a polyimide having such a property. Note that the softening temperature can be determined by using a thermomechanical analyzer (manufactured by Rigaku Corporation under the trade name of “TMA 8310”) in a penetration mode. In addition, for the measurement, since the size (length, width, thickness, and the like) of the sample does not exert any influence on the measured value, the size of the sample only needs to be adjusted, as appropriate, to a size mountable on a jig of a thermomechanical analyzer (manufactured by Rigaku Corporation under the trade name of “TMA8310”) used.

In addition, the polyimide has a thermal decomposition temperature (Td) of preferably 450° C. or higher, and more preferably 480 to 600° C. If the thermal decomposition temperature (Td) is lower than the lower limit, it tends to be difficult to achieve a sufficient heat resistance. Meanwhile, if the thermal decomposition temperature (Td) exceeds the upper limit, it tends to be difficult to produce a polyimide having such a property. Note that the thermal decomposition temperature (Td) can be determined by measuring the temperature at an intersection of tangent lines drawn to decomposition curves before and after thermal decomposition using a TG/DTA220 thermogravimetric analyzer (manufactured by SII NanoTechnology Inc.) under a nitrogen atmosphere under a condition of a rate of temperature rise of 10° C./min.

In addition, the polyimide has a linear expansion coefficient (CTE) of preferably 0 to 100 ppm/K, and more preferably 10 to 70 ppm/K. If the linear expansion coefficient exceeds the upper limit, the polyimide tends to be easily peeled off because of thermal history when a composite material is formed by combining the polyimide with a metal or inorganic material having a linear expansion coefficient in a range from 5 to 20 ppm/K. Meanwhile, if the linear expansion coefficient is lower than the lower limit, the solubility tends to decrease and film properties tend to deteriorate.

As a method for measuring the linear expansion coefficient of a polyimide, a method described below is employed. Specifically, first, a polyimide film having a size of 20 mm in length and 5 mm in width (the thickness of the film is not particularly limited because it does not exert any influence on the measured value, and is preferably 5 to 80 μm) is formed as a measurement sample. By using a thermomechanical analyzer (manufactured by Rigaku Corporation under the trade name of “TMA8310”) as a measuring apparatus, and employing conditions of a tensile mode (49 mN) and a rate of temperature rise of 5° C./min under a nitrogen atmosphere, the temperature is raised from room temperature to 200° C. (first temperature rise), and the temperature is allowed to drop to 30° C. or lower. Then, the temperature is raised from that temperature to 400° C. (second temperature rise). During this temperature rise, the change in length of the sample in the longitudinal direction thereof is measured. Subsequently, a TMA curve obtained by the measurement during the second temperature rise (the measurement during the temperature rise from the temperature after the temperature drop to 400° C.) is used to determine the average value of the changes in length per degree Celsius in the temperature range from 100° C. to 200° C. The obtained value is employed as the linear expansion coefficient of the polyimide in the measurement. As described above, a value obtained by determining the average value of changes in length per degree Celsius in the temperature range from 100° C. to 200° C. on the basis of the TMA curve is employed as the linear expansion coefficient of a polyimide of the present invention.

Further, the polyimide has a number average molecular weight (Mn) of preferably 1000 to 1000000, and more preferably 10000 to 500000, in terms of polystyrene. If the number average molecular weight is less than the lower limit, it tends to be difficult to not only achieve a sufficient heat resistance but also efficiently obtain the polyimide because the polyimide does not sufficiently precipitate from an organic solvent during the production. Meanwhile, if the number average molecular weight exceeds the upper limit, the viscosity is increased, and it takes a long time for the dissolution or a large amount of a solvent is required, so that processing tends to be difficult.

In addition, the polyimide has a weight average molecular weight (Mw) of preferably 1000 to 5000000 in terms of polystyrene. In addition, a lower limit value of the numeric value range of the weight average molecular weight (Mw) is more preferably 5000, further preferably 10000, and particularly preferably 20000. In addition, an upper limit value of the numeric value range of the weight average molecular weight (Mw) is more preferably 5000000, further preferably 500000, and particularly preferably 100000. If the weight average molecular weight is less than the lower limit, it tends to be difficult to not only achieve a sufficient heat resistance but also efficiently obtain the polyimide because the polyimide does not sufficiently precipitate from an organic solvent during the production. Meanwhile, if the weight average molecular weight exceeds the upper limit, the viscosity is increased, and it takes a long time for the dissolution or a large amount of a solvent is required, so that processing tends to be difficult.

Further, the polyimide has a molecular weight distribution (Mw/Mn) of preferably 1.1 to 5.0, and more preferably 1.5 to 3.0. If the molecular weight distribution is less than the lower limit, the production tends to be difficult. Meanwhile, if the molecular weight distribution exceeds the upper limit, it tends to be difficult to obtain a uniform film. Note that the molecular weight (Mw or Mn) and the molecular weight distribution (Mw/Mn) of the polyimide can be determined by converting, in terms of polystyrene, data measured using a measuring apparatus of a gel permeation chromatography (GPC) measuring apparatus (degasser: DG-2080-54 manufactured by JASCO Corporation, liquid transfer pump: PU-2080 manufactured by JASCO Corporation, interface: LC-NetII/ADC manufactured by JASCO Corporation, column: GPC column KF-806M (×two) manufactured by Shodex, column oven: 860-CO manufactured by JASCO Corporation, RI detector: RI-2031 manufactured by JASCO Corporation at a column temperature of 40° C. with a chloroform solvent (flow rate: 1 mL/min.).

Note that when the molecular weight of a polyimide is difficult to measure, a polyimide may be selected and used according to the application or the like by estimating the molecular weight and the like on the basis of the viscosity of a polyamic acid used for producing the polyimide.

In addition, the polyimide is preferably one having a sufficiently high transparency when formed into a film, and the film has a total luminous transmittance of more preferably 80% or higher (further preferably 85% or higher, and particularly preferably 87% or higher). Such a total luminous transmittance can be achieved easily by selecting, as appropriate, the type of the polyimide and the like.

In addition, the polyimide is more preferably one having a haze (turbidity) of 5 to 0 (further preferably 4 to 0, and particularly preferably 3 to 0), from the viewpoint of obtaining a higher colorlessness and transparency. If the haze value exceeds the upper limit, it tends to be difficult to achieve colorlessness and transparency at a higher level.

Moreover, the polyimide is more preferably one having a yellowness index (YI) of 5 to 0 (further preferably 4 to 0, and particularly preferably 3 to 0), for example, from the viewpoint of obtaining a higher colorlessness and transparency. If the yellowness index exceeds the upper limit, it tends to be difficult to achieve colorlessness and transparency at a higher level.

As the total luminous transmittance, the haze (turbidity), and the yellowness index (YI), values can be employed which are measured by using a measuring apparatus manufactured by NIPPON DENSHOKU INDUSTRIES CO., LTD. under the trade name of “Haze Meter NDH-5000” or a measuring apparatus manufactured by NIPPON DENSHOKU INDUSTRIES CO., LTD. under the trade name of “Spectrophotometer SD6000” (the total luminous transmittance and the haze are measured with the measuring apparatus manufactured by NIPPON DENSHOKU INDUSTRIES CO., LTD. under the trade name of “Haze Meter NDH-5000” and the yellowness index is measured with the measuring apparatus manufactured by NIPPON DENSHOKU INDUSTRIES CO., LTD. under the trade name of “Spectrophotometer SD6000”) and using a film made of a polyimide having a thickness of 5 to 100 μm as a measurement sample. In addition, the size (the length and width) of the measurement sample only needs to be a size which allows the measurement sample to be placed in a measuring site of the measuring apparatus, and the size (the length and width) may be changed, as appropriate. Note that the total luminous transmittance is determined by conducting the measurement according to JIS K7361-1 (published in 1997), the haze (turbidity) is determined by conducting the measurement according to JIS K7136 (published in 2000), and the yellowness index (YI) is determined by conducting the measurement according to ASTM E313-05 (published in 2005).

The absolute value of the thickness-direction retardation (Rth) of the polyimide measured at a wavelength 590 nm and converted to a value for a thickness of 10 μm is preferably 150 nm or less, more preferably 100 nm or less, further preferably 50 nm or less, and particularly preferably 25 nm or less. In other words, the value of the retardation (Rth) is preferably −150 nm to 150 nm (more preferably −100 nm to 100 nm, further preferably −50 to 50 nm, and particularly preferably −25 to 25 nm). If the absolute value of the thickness-direction retardation (Rth) exceeds the upper limit, the contrast tends to be lowered and the viewing angle tends to decrease when the polyimide is used for a display device. Note that when the absolute value of the retardation (Rth) is within the above-described range, an effect of suppressing the lowering in contrast and an effect of improving the viewing angle tend to be greater when the polyimide is used for a display device. Accordingly, the absolute value of the thickness-direction retardation (Rth) is preferably a lower value, from the viewpoints that the lowering in contrast can be suppressed at a higher level and that the viewing angle can be further improved when the polyimide is used for a display device.

“The absolute value of the thickness-direction retardation (Rth)” can be determined using a measuring apparatus manufactured by AXOMETRICS, Inc. under the trade name of “AxoScan” by inputting, into the measuring apparatus, a value of a refractive index (589 nm) of the polyimide film measured as described later; then, measuring the thickness-direction retardation of the polyimide film by using light at a wavelength of 590 nm under conditions of a temperature: 25° C. and a humidity: 40%; determining a value (converted value) converted into a retardation value per 10 μm of the thickness of the film on the basis of the measured values of the thickness-direction retardation thus determined (values measured according to the automatic measurement (automatic calculation) of the measuring apparatus); and calculating the absolute value from the converted value. In this manner, “the absolute value of the thickness-direction retardation (Rth)” can be determined by calculating the absolute value (|converted value|) of the converted value. Note that the size of the polyimide film as the measurement sample is not particularly limited, as long as it is larger than a light measurement unit (diameter: approximately 1 cm) of a stage of the measuring apparatus. Nevertheless, the size is preferably a length: 76 mm, a width: 52 mm, and a thickness: 5 to 20 μm.

In addition, the value of the “refractive index (589 nm) of the polyimide film” utilized in the measurement of the thickness-direction retardation (Rth) can be determined by forming an unstretched film made of the same kind of polyimide as the polyimide for forming the film to be measured for the retardation; and then, measuring the unstretched film as a measurement sample (note that in the case where the film to be measured is an unstretched film, the film can be directly used as the measurement sample) for the refractive index for light at 589 nm in an in-plane direction (the direction perpendicular to the thickness direction) of the measurement sample by using a refractive index-measuring apparatus (manufactured by Atago Co., Ltd. under the trade name of “NAR-IT SOLID”) as a measuring apparatus under a light source of 589 nm and a temperature condition of 23° C. Note that since the measurement sample is unstretched, the refractive index in the in-plane direction of the film is the same in any direction in the plane, and measuring this refractive index makes it possible to measure the intrinsic refractive index of the polyimide (note that since the measurement sample is unstretched, Nx=Ny is satisfied, where Nx is a refractive index in a direction of a slow axis in the plane, and Ny is a refractive index in an in-plane direction perpendicular to the direction of the slow axis). Accordingly, an unstretched film is utilized to measure the intrinsic refractive index (589 nm) of the polyimide, and the measurement value thus obtained is utilized in the measurement of the above-described thickness-direction retardation (Rth). Here, the size of the polyimide film as a measurement sample is not particularly limited, as long as the size can be utilized in the refractive index-measuring apparatus. The size may be 1 cm square (1 cm in length and width) and 5 to 20 μm in thickness.

The shape of the polyimide is not particularly limited, and, for example, may be a film shape or a powder shape, or even may be a pellet shape formed by extrusion molding, or the like. As described above, the polyimide of the present invention can be formed into a film shape or into a pellet shape by extrusion molding, or can be formed, as appropriate, into various shapes by known methods.

In addition, the polyimide is especially useful as a material for producing films for flexible wiring boards, heat-resistant insulating tapes, enameled wires, protective coating agents for semiconductors, liquid crystal orientation films, transparent electrically conductive films for organic EL, flexible substrate films, flexible transparent electrically conductive films, transparent electrically conductive films for organic thin film-type solar cells, transparent electrically conductive films for dye-sensitized-type solar cells, flexible gas barrier films, films for touch panels, TFT substrate films for flat panel detectors, seamless polyimide belts (so-called transfer belts) for copiers, transparent electrode substrates (such as transparent electrode substrates for organic EL, transparent electrode substrates for solar cells, and transparent electrode substrates for electronic papers), interlayer insulating films, sensor substrates, image sensor substrates, reflective plates for light-emitting diodes (LEDs)(reflective plates for LED lighting devices: LED reflective plates), covers for LED lighting devices, covers for LED reflective plate lighting devices, coverlay films, high-ductility composite substrates, resists for semiconductors, lithium-ion batteries, substrates for organic memories, substrates for organic transistors, substrates for organic semiconductors, color filter substrates, and the like. In addition to the above-described applications, the polyimide can also be used, as appropriate, for, for example, automotive components, aerospace and aviation components, bearing components, sealing materials, bearing components, gear wheel and valve components, and the like by being shaped into a powder or any of various formed articles, or the like.

Note that a method which can be preferably employed to produce the polyimide of the present invention is described later. Hereinabove, the polyimide of the present invention has been described. Next, a polyamic acid of the present invention is described.

### [Polyamic Acid]

A polyamic acid of the present invention comprises at least one repeating unit selected from the group consisting of:

a repeating unit (A2) represented by the following general formula (4):

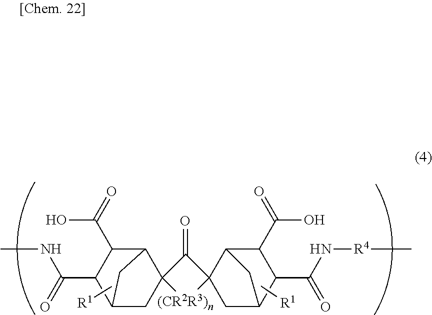

[in the formula (4), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the general formula (X)];

a repeating unit (B2) represented by the following general formula (5):

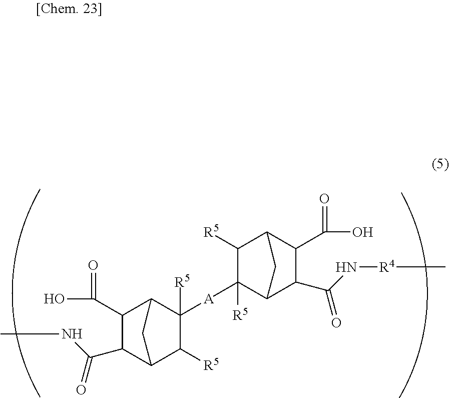

[in the formula (5), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms]; and

a repeating unit (C2) represented by the following general formula (6):

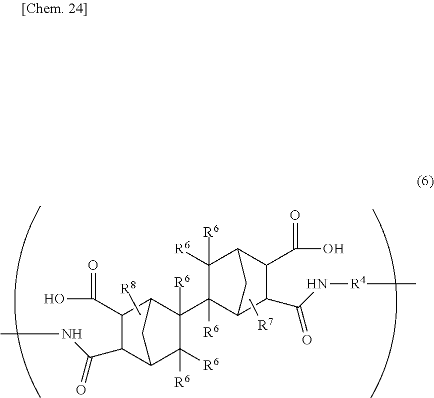

[in the formula (6), R⁴ represents an arylene group represented by the general formula (X), multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms].

<Repeating Unit (A2)>

The repeating unit (A2) which may be contained in the polyamic acid of the present invention is a repeating unit represented by the general formula (4) described above. R¹s, R², R³, R⁴, and n in the general formula (4) are the same as R¹s, R², R³, R⁴, and n in the general formula (1) of the repeating unit (A1), and preferred ones thereof are also the same as those of R¹s, R², R³, R⁴, and n in the general formula (1) of the repeating unit (A1).

<Repeating Unit (B2)>

The repeating unit (B2) which may be contained in the polyamic acid of the present invention is a repeating unit represented by the general formula (5) described above. R⁴, R⁵s, and A in the general formula (5) are the same as R⁴, R⁵s, and A in the general formula (2) of the repeating unit (B1), and preferred ones thereof are also the same as those of R⁴, R⁵s, and A in the general formula (2) of the repeating unit (B1).

<Repeating Unit (C2)>

The repeating unit (C2) which may be contained in the polyamic acid of the present invention is a repeating unit represented by the general formula (6). R⁴, R⁶s, R⁷, and R⁸ in the general formula (6) are the same as R⁴, R⁶s, R⁷, and R⁸ in the above-described general formula (3) of the repeating unit (C1), and preferred ones thereof are also the same as those of R, R⁶s, R, and R in the above-described general formula (3) of the repeating unit (C1).

<Polyamic Acid>

The polyamic acid of the present invention comprises at least one repeating unit selected from the group consisting of the repeating unit (A2), the repeating unit (B2), and the repeating unit (C2).

The polyamic acid is preferably such that the total amount (sum) of the repeating unit (A2), the repeating unit (B2), and the repeating unit (C2) is 30 to 100% by mole (further preferably 40 to 100% by mole, more preferably 50 to 100% by mole, further preferably 70 to 100% by mole, particularly preferably 80 to 100% by mole, and most preferably 90 to 100% by mole) relative to all repeating units. If the total amount is less than the lower limit, the heat resistance of a polyimide formed by using such a polyamic acid based on the Tg of the polyimide tends to be lowered.

Note that the polyamic acid may comprise an additional repeating unit within a range not impairing an effect of the present invention. The additional repeating unit is not particularly limited, and examples thereof include known repeating units which can be used as repeating units of polyamic acids, and the like. Note that the additional repeating unit is preferably at least one selected from the group consisting of a repeating unit (A″) represented by the general formula (4) in which R⁴ is an arylene group having 6 to 40 carbon atoms and being other than the arylene group represented by the general formula (X), a repeating unit (B″) represented by the general formula (5) in which R⁴ is an arylene group having 6 to 40 carbon atoms and being other than the arylene group represented by the general formula (X), and a repeating unit (C′) represented by the general formula (6) in which R⁴ is an arylene group having 6 to 40 carbon atoms and being other than the arylene group represented by the general formula (X). Note that R⁴ (an arylene group having 6 to 40 carbon atoms and being other than the arylene group represented by the general formula (X)) in each of the repeating units (A″), (B″), and (C′)) is the same as R⁴ in each of the repeating units (A′), (B′), and (C′) described for the polyimide above (preferred ones thereof are also the same). Note that the repeating units (A″), (B″), and (C″) can be introduced into the polyimide by using an aromatic diamine represented by the general formula (103).

In addition, the polyamic acid has an intrinsic viscosity [η] of preferably 0.05 to 3.0 dL/g, and more preferably 0.1 to 2.0 dL/g. If the intrinsic viscosity [η] is lower than 0.05 dL/g, the obtained film tends to be brittle, when a polyimide in the form of a film is produced by using this polyamic acid. Meanwhile, if the intrinsic viscosity [η] exceeds 3.0 dL/g, the viscosity is so high that the processability decreases, for example, making it difficult to obtain a uniform film when a film is produced. In addition, the intrinsic viscosity [η] can be determined as follows. Specifically, first, N,N-dimethylacetamide is used as a solvent, and the polyamic acid is dissolved in the N,N-dimethylacetamide at a concentration of 0.5 g/dL to obtain a measurement sample (solution). Next, by using the measurement sample, the viscosity of the measurement sample is measured by using a kinematic viscometer under a temperature condition of 30° C., and the determined value is employed as the intrinsic viscosity [η]. Note that, as the kinematic viscometer, an automatic viscometer manufactured by RIGO CO., LTD. (trade name: “VMC-252”) is used.

In addition, the polyamic acid can be preferably used when the polyimide of the present invention is produced (the polyamic acid can be obtained as a reaction intermediate (precursor) when the polyimide of the present invention is produced). Hereinafter, a method which can be preferably employed as a method for producing the polyamic acid is described.

<Method Which Can Be Preferably Employed as Method for Producing Polyamic Acid>

A method which can be preferably employed as a method for producing the polyamic acid of the present invention may be, for example, a method in which the above-described polyamic acid of the present invention is obtained by reacting at least one compound selected from the group consisting of a raw material compound (A) represented by the above-described general formula (101), a raw material compound (B) represented by the above-described general formula (201), and a raw material compound (C) represented by the above-described general formula (301) with an aromatic diamine represented by the general formula (102) in the presence of an organic solvent.

The raw material compounds (A) to (C) used in the method are the same as those described above for the polyimide of the present invention (preferred ones thereof are also the same).

The organic solvent used in the method is preferably an organic solvent capable of dissolving both the raw material compounds (A) to (C) and the aromatic diamine. Examples of the organic solvent include aprotic polar solvents such as N-methyl-2-pyrrolidone, N,N-dimethylacetamide, N,N-dimethylformamide, dimethyl sulfoxide, γ-butyrolactone, propylene carbonate, tetramethylurea, 1,3-dimethyl-2-imidazolidinone, hexamethylphosphoric triamide, and pyridine; phenol-based solvents such as m-cresol, xylenol, phenol, and halogenated phenols; ether-based solvents such as tetrahydrofuran, dioxane, Cellosolve, and glyme; aromatic solvents such as benzene, toluene, and xylene; and the like. One of these organic solvents may be used alone, or two or more thereof may be used as a mixture.

In addition, the ratio of the amount of at least one compound (tetracarboxylic dianhydride) selected from the group consisting of the raw material compounds (A) to (C) used (the total amount of the raw material compounds (A) to (C)) and the amount of the aromatic diamine represented by the general formula (102) used is not particularly limited, and the amount of all acid anhydride groups in the tetracarboxylic dianhydride(s) used in the reaction is preferably 0.2 to 2 equivalents, and more preferably 0.3 to 1.2 equivalents per equivalent of the amino groups of the aromatic diamine represented by the general formula (102). If the preferred ratio of the tetracarboxylic dianhydrides (the raw material compounds (A) to (C)) and the aromatic diamine represented by the general formula (102) used is lower than the lower limit, the polymerization reaction tends not to proceed efficiently, so that a polyamic acid having a high molecular weight cannot be obtained. Meanwhile, if the ratio exceeds the upper limit, a polyamic acid having a high molecular weight tends not to be obtained as in the above described case.

Moreover, the amount of the organic solvent used is preferably such that the total amount (the total amount of the reactants [substrates]) of the amount of the tetracarboxylic dianhydrides used in the reaction (the total amount of the raw material compounds (A) to (C) used in the reaction) and the amount of the aromatic diamine represented by the general formula (102) can be 1 to 80% by mass (more preferably 5 to 50% by mass) relative to the total amount of the reaction solution. If the amount of the organic solvent used is less than the lower limit, the polyamic acid tends not to be obtained efficiently. Meanwhile, if the amount of the organic solvent used exceeds the upper limit, the viscosity tends to increase, making the stirring difficult, so that a polymer having a high molecular weight cannot be obtained.

In addition, when the tetracarboxylic dianhydrides (at least two compounds selected from the group consisting of the raw material compounds (A) to (C)) and the aromatic diamine represented by the general formula (102) are reacted with each other, a basic compound may be further added to the organic solvent from the viewpoints of improving the reaction rate and obtaining a polyamic acid with a high degree of polymerization. The basic compound is not particularly limited, and examples thereof include triethylamine, tetrabutylamine, tetrahexylamine, 1,8-diazabicyclo[5.4.0]-undecene-7, pyridine, isoquinoline, α-picoline, and the like. In addition, the amount of the basic compound used is preferably 0.001 to 10 equivalents, and more preferably 0.01 to 0.1 equivalents per equivalent of the tetracarboxylic dianhydride represented by the general formula (1). If the amount of the basic compound used is less than the lower limit, the effect achieved by the addition tends not to be exhibited. Meanwhile, if the amount of the basic compound used exceeds the upper limit, the basic compound tends to cause color development or the like.

In addition, the reaction temperature at which the tetracarboxylic dianhydrides (at least two compounds selected from the group consisting of the raw material compounds (A) to (C)) and the aromatic diamine represented by the general formula (102) are reacted with each other is not particularly limited, as long as the temperature is adjusted, as appropriate, to a temperature at which these compounds can react with each other. The reaction temperature is preferably 15 to 100° C. In addition, a method for reacting the tetracarboxylic dianhydride represented by the general formula (1) with the aromatic diamine represented by the general formula (6) is not particularly limited, and it is possible to use, as appropriate, a method by which a polymerization reaction between a tetracarboxylic dianhydride and an aromatic diamine can be conducted. For example, a method may be employed in which the aromatic diamine is dissolved in the solvent under atmospheric pressure in an inert atmosphere of nitrogen, helium, argon, or the like, then the tetracarboxylic dianhydride represented by the general formula (1) is added at the reaction temperature, and then the reaction is allowed to proceed for 10 to 48 hours. If the reaction temperature or the reaction time is lower or less than the lower limit, it tends to be difficult to cause the reaction to proceed sufficiently. Meanwhile, if the reaction temperature or the reaction time exceeds the upper limit, the possibility of contamination with a substance (such as oxygen) that degrades the polymerization product tends to increase, so that the molecular weight decreases.

Reacting at least one compound selected from the group consisting of the raw material compound (A), the raw material compound (B), the raw material compound (C) with the aromatic diamine represented by the general formula (102) in the presence of an organic solvent as described above makes it possible to obtain the above-described polyamic acid of the present invention (the polyamic acid comprising at least one repeating unit selected from the group consisting of the repeating unit (A2), the repeating unit (B2), and the repeating unit (C2)).

Note that when a polyamic acid comprising an additional repeating unit other than the repeating unit (A2), the repeating unit (B2), and the repeating unit (C2) is prepared as the polyamic acid obtained by the present invention, a method therefor is not particularly limited. For example, for producing such a polyamic acid, it is possible to employ a method in which the above-described aromatic diamine represented by the general formula (103) is used together with the aromatic diamine represented by the general formula (102) and the raw material compounds (A) to (C) are reacted with these aromatic diamines, or a method in which an additional tetracarboxylic dianhydride other than the raw material compounds (A) to (C) is used together with the raw material compounds (A) to (C), and these are reacted with the aromatic diamine.

The additional tetracarboxylic dianhydride is not particularly limited, and examples thereof include aliphatic or alicyclic tetracarboxylic dianhydrides such as butanetetracarboxylic dianhydride, 1,2,3,4-cyclobutanetetracarboxylic dianhydride, 1,2,3,4-cyclopentanetetracarboxylic dianhydride, 1,2,4,5-cyclohexanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-dioxo-3-furanyl)-naphtho [1,2-c]-furan-1,3-dione, 1,3,3a,4,5,9b-hexahydro-8-methyl-5-(tetrahydro-2,5-dioxo-3-furanyl)-naphtho[1,2-c]-furan-1,3-dione, 5-(2,5-dioxotetrahydrofural)-3-methyl-3-cyclohexene-1,2-dicarboxylic dianhydride, and bicyclo[2,2,2]-oct-7-ene-2,3,5,6-tetracarboxylic dianhydride; aromatic tetracarboxylic dianhydrides such as pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenyl sulfide dianhydride, 4,4′-bis(3,4-dicarboxyphenoxy)diphenyl sulfone dianhydride, 4,4′-bis(3,4-dicarboxyphenoxy)diphenylpropane dianhydride, 3,3′,4,4′-perfluoroisopropylidenediphthalic dianhydride, 4,4′-(2,2-hexafluoroisopropylidene)diphthalic dianhydride, 3,3′,4,4′-biphenyltetracarboxylic dianhydride, 2,3,3′,4′-biphenyltetracarboxylic dianhydride, bis(phthalic acid)phenylphosphine oxide dianhydride, p-phenylene-bis(triphenylphthalic) dianhydride, m-phenylene-bis(triphenylphthalic) dianhydride, bis(triphenylphthalic acid)-4,4′-diphenyl ether dianhydride, and bis(triphenylphthalic acid)-4,4′-diphenylmethane dianhydride; and the like.

Hereinabove, the method which can be preferably employed as a method for producing the polyamic acid of the present invention has been described. Next, a method which can be preferably employed as a method for producing the above-described polyimide of the present invention is described.

<Method Which Can Be Preferably Employed as Method for Producing Polyimide>

The method which can be preferably employed as a method for producing the polyimide is not particularly limited. For example, a method can be employed in which the polyimide is obtained by reacting

at least one compound (hereinafter, sometimes simply referred to as “tetracarboxylic dianhydride”) selected from the group consisting of the raw material compound (A) represented by the above-described general formula (101), the raw material compound (B) represented by the above-described general formula (201), and the raw material compound (C) represented by the above-described general formula (301) with

the aromatic diamine represented by the general formula (102)

in the presence of an organic solvent. Especially, it is more preferable to employ a production method comprising:

a step (I) of reacting
at least one compound (hereinafter, sometimes simply referred to as “tetracarboxylic dianhydride”) selected from the group consisting of the raw material compound (A) represented by the above-described general formula (101), the raw material compound (B) represented by the above-described general formula (201), and the raw material compound (C) represented by the above-described general formula (301) with
the aromatic diamine represented by the general formula (102)
   in the presence of an organic solvent to obtain the above-described polyamic acid of the present invention; and

a step (II) of conducting imidization of the polyamic acid to obtain the above-described polyimide of the present invention. Hereinafter, the method comprising the steps (I) and (II) is described.

As the step (I), it is preferable to employ a method which is the same as the method described in “Method Which Can Be Preferably Employed as Method for Producing Polyamic Acid” above.

Meanwhile, the step (II) is a step of conducting imidization of the polyamic acid to obtain the above-described polyimide of the present invention. The method for imidization of the polyamic acid is not particularly limited, as long as imidization of the polyamic acid can be conducted by the method, and a known method can be employed, as appropriate. For example, it is preferable to employ a method in which imidization of the polyamic acid is conducted by using an imidization agent such as a so-called condensation agent, a method in which the imidization is conducted by subjecting the polyamic acid to a heating treatment under a temperature condition of 60 to 450° C. (more preferably 80 to 400° C.), or the like.

When the method in which the imidization of the polyamic acid is conducted by using an imidization agent such as a so-called condensation agent is employed for the imidization, it is preferable to conduct the imidization of the above-described polyamic acid of the present invention in a solvent in the presence of the condensation agent. As the solvent, the same organic solvents as those used for the above-described method for producing the polyamic acid of the present invention can be used preferably. When the method in which the imidization is conducted using an imidization agent such as a so-called condensation agent is employed as described above, it is preferable to employ a step of conducting chemical imidization of the polyamic acid by using an imidization agent such as a condensation agent in the organic solvent to obtain the polyimide.

Moreover, when the imidization is conducted by employing the chemical imidization using an imidization agent such as a condensation agent, the imidization step described in the step (II) is more preferably a step of conducting dehydration ring-closure of the polyamic acid by using a dehydration condensation agent (a carboxylic anhydride, a carbodiimide, an acid azide, an active ester forming agent, or the like) as the condensation agent and a reaction accelerator (a tertiary amine or the like) to conduct the imidization. When such a step is employed, heating at high temperature does not necessarily have to be conducted for the imidization, so that the polyimide can be obtained by imidization under a low-temperature condition (more preferably under a temperature condition of about 100° C. or lower).

When the imidization is conducted by employing such chemical imidization, the reaction liquid (a reaction liquid containing the above-described polyamic acid of the present invention) which has been obtained in the step (I) by reacting the above-described tetracarboxylic dianhydride with the above-described aromatic diamine in the organic solvent may then be used directly to conduct the chemical imidization using a condensation agent. Note that, after conducting the step (I), the polyamic acid may be isolated, and then the chemical imidization may be conducted after the polyamic acid is added into an organic solvent again.

In addition, the condensation agent used when the chemical imidization is employed in the step (II) may be any, as long as the condensation agent can be utilized to form a polyimide by condensation of the polyamic acid, and it is possible to use, as appropriate a known compound used as a so-called “imidization agent” in combination with a reaction accelerator described later. The condensation agent is not particularly limited, and examples thereof include carboxylic anhydrides such as acetic anhydride, propionic anhydride, and trifluoroacetic anhydride; carbodiimides such as N,N′-dicyclohexylcarbodiimide (DCC); acid azides such as diphenylphosphoryl azide (DPPA); active ester-forming agents such as Castro's reagent; and dehydration condensation agents such as 2-chloro-4,6-dimethoxytriazine (CDMT). Of these condensation agents, acetic anhydride, propionic anhydride, and trifluoroacetic anhydride are preferable, acetic anhydride and propionic anhydride are more preferable, and acetic anhydride is further preferable from the viewpoints of reactivity, availability, and practicability. One of these condensation agents may be used alone, or two or more thereof may be used in combination.

In addition, the reaction accelerator may be any, as long as the reaction accelerator can be used for conversion of the polyamic acid to a polyimide by condensation, and a known compound can be used, as appropriate. The reaction accelerator can also function as an acid scavenger that captures an acid by-produced during the reaction. For this reason, the use of the reaction accelerator accelerates the reaction and suppresses the reverse reaction due to the by-produced acid, so that the reaction can be caused to proceed efficiently. The reaction accelerator is not particularly limited, and is more preferably one also having a function of an acid scavenger. Examples of such a reaction accelerator include tertiary amines such as triethylamine, diisopropylethylamine, N-methylpiperidine, pyridine, collidine, lutidine, 2-hydroxypyridine, 4-dimethylaminopyridine (DMAP), 1,4-diazabicyclo[2.2.2]octane (DABCO), diazabicyclononene (DBN), and diazabicycloundecene (DBU), and the like. Of these reaction accelerators, triethylamine, diisopropylethylamine, N-methylpiperidine, and pyridine are preferable, triethylamine, pyridine, and N-methylpiperidine are more preferable, and triethylamine and N-methylpiperidine are further preferable from the viewpoints of reactivity, availability, and practicability. One of those reaction accelerators may be used alone, or two or more thereof may be used in combination.

In addition, the chemical imidization may be conducted by, for example, adding a catalytic amount of a reaction accelerator (such as DMAP) and an azeotropic dehydration agent (such as benzene, toluene, or xylene), and removing water produced when the polyamic acid is converted to the imide by azeotropic dehydration. For the chemical imidization, the azeotropic dehydration agent may be used, as appropriate, together with the reaction accelerator as described above. The azeotropic dehydration agent is not particularly limited, and an azeotropic dehydration agent may be selected from known azeotropic dehydration agents and used, as appropriate, according to the type of the material used for the reaction and the like.

In addition, when the chemical imidization is conducted by using the condensation agent and the reaction accelerator, it is more preferable to employ a method in which the polyamic acid obtained after the step (I) is conducted is not isolated, but the reaction liquid (the reaction liquid containing the above-described polyamic acid of the present invention) obtained by reacting the above-described tetracarboxylic dianhydride with the above-described aromatic diamine in an organic solvent is used directly, and the imidization is conducted by adding the condensation agent (imidization agent) and the reaction accelerator to the reaction liquid, from the viewpoint of producing the polyimide more efficiently.

In addition, a temperature condition for the chemical imidization is preferably −40° C. to 200° C., more preferably −20° C. to 150° C., further preferably 0 to 150° C., and particularly preferably 50 to 100° C. If the temperature is higher than the upper limit, an undesirable side reaction tends to proceed, so that the polyimide cannot be obtained. Meanwhile, if the temperature is lower than the lower limit, the reaction rate of the chemical imidization tends to be lowered or the reaction itself tends to not proceed, so that the polyimide cannot be obtained. As described above, when the chemical imidization is employed, it is also possible to conduct the imidization in a temperature range of relatively low temperatures, for example, −40° C. to 200° C., and this can reduce the environmental load.

In addition, the reaction time of the chemical imidization is preferably 0.1 to 48 hours. If the reaction temperature or the reaction time is lower or less than the lower limit, it tends to be difficult to conduct the imidization sufficiently, and it tends to be difficult to cause precipitation of the polyimide in the organic solvent. Meanwhile, if the reaction temperature or the reaction time exceeds the upper limit, the possibility of contamination with a substance (such as oxygen) that degrades the polymerization product tends to increase, and the molecular weight tends to decrease, rather.

In addition, the amount of the condensation agent used is not particularly limited, and is preferably 0.05 to 4.0 moles, and further preferably 1 to 2 moles per mole of the repeating unit in the polyamic acid. If the amount of the condensation agent (imidization agent) used is less than the lower limit, the reaction rate of the chemical imidization tends to be lowered or the reaction itself tends not to proceed sufficiently, so that the polyimide cannot be obtained sufficiently. Meanwhile, if the amount of the condensation agent exceeds the upper limit, the polyimide tends not to be obtained efficiently, for example, because an undesirable side reaction proceeds.

In addition, the amount of the reaction accelerator used for the chemical imidization is not particularly limited, and is preferably 0.05 to 4.0 moles, and further preferably 1 to 2 moles per mole of the repeating unit in the polyamic acid. If the amount of the reaction accelerator used is less than the lower limit, the reaction rate of the chemical imidization tends to be lowered or the reaction itself tends not to proceed sufficiently, so that the polyimide cannot be obtained sufficiently. Meanwhile, if the amount of the reaction accelerator used exceeds the upper limit, the polyimide tends not to be obtained efficiently, for example, because an undesirable side reaction proceeds.

In addition, an atmosphere condition for the chemical imidization is preferably an inert gas atmosphere of nitrogen gas or the like or a vacuum condition, from the viewpoint of preventing color development due to oxygen in the air and molecular weight reduction due to water vapor in the air. In addition, a pressure condition for the chemical imidization is not particularly limited, and is preferably 0.01 hPa to 1 MPa, and more preferably 0.1 hPa to 0.3 MPa. If the pressure is lower than the lower limit, the solvent, the condensation agent, and the reaction accelerator tend to be gasified, so that the stoichiometry is disturbed and an adverse influence is exerted on the reaction, making it difficult to cause the reaction to proceed sufficiently. Meanwhile, if the pressure exceeds the upper limit, an undesirable side reaction tends to proceed, or the solubility of the polyamic acid tends to decease, so that precipitation occurs.

In addition, for the imidization in the step (II), it is also possible to employ a method in which the imidization is conducted by performing a treatment (heating treatment) of heating the polyamic acid under a temperature condition of 60 to 450° C. (more preferably 80 to 400° C.) as mentioned above. In the case where the method in which the imidization is conducted by performing the heating treatment is employed, if the heating temperature is lower than the lower limit, the reaction tends to be sluggish. Meanwhile, if the heating temperature exceeds the upper limit, color development tends to occur and decrease in molecular weight tends to occur due to thermal decomposition. In addition, when the method in which the imidization is conducted by performing the heating treatment is employed, the reaction time (heating time) is preferably 0.5 to 5 hours. If the reaction time is less than the lower limit, it tends to be difficult to conduct the imidization sufficiently. Meanwhile, if the reaction time exceeds the upper limit, color development tends to occur and decrease in molecular weight tends to occur due to thermal decomposition.

In addition, when the imidization is conducted by performing the heating treatment, a so-called reaction accelerator may be used in order to obtain a higher molecular weight and promote the imidization. As the reaction accelerator, a known reaction accelerator (a tertiary amine such as triethylamine, diisopropylethylamine, N-methylpiperidine, pyridine, collidine, lutidine, 2-hydroxypyridine, 4-dimethylaminopyridine (DMAP), 1,4-diazabicyclo[2.2.2]octane (DABCO), diazabicyclononene (DBN), or diazabicycloundecene (DBU), or the like) may be used, as appropriate. In addition, of these reaction accelerators, triethylamine, diisopropylethylamine, N-methylpiperidine, and pyridine are preferable, triethylamine, pyridine, and N-methylpiperidine are more preferable, and triethylamine and N-methylpiperidine are further preferable from the viewpoints of reactivity, availability, and practicability. One of these reaction accelerators may be used alone, or two or more thereof may be used in combination. In addition, when the imidization is conducted by performing the heating treatment, the amount of the reaction accelerator used is not particularly limited, and, for example, is preferably 0.01 to 4.0 moles, more preferably 0.05 to 2.0 moles, and further preferably 0.05 to 1.0 moles per mole of the repeating unit in the polyamic acid.

In addition, when the method comprising the step (I) and the step (II) is used and the method in which the imidization is conducted by performing the heating treatment is employed for the imidization, it is also possible to employ a method in which the above-described polyamic acid of the present invention is not isolated after the step (I) is conducted, but the reaction liquid (the reaction liquid comprising the polyamic acid) obtained by reacting the tetracarboxylic dianhydride with the aromatic diamine in an organic solvent is used directly, and after the reaction liquid is subjected to a treatment (solvent removal treatment) for removing the solvent by evaporation to remove the solvent, and the imidization is conducted by performing the heating treatment. The treatment for removing the solvent by evaporation, for example, makes it possible to obtain the polyimide in a desired form by isolating the polyamic acid in a form of film or the like and then conducting the heating treatment.

A temperature condition of the treatment (solvent removal treatment) for removing the solvent by evaporation is preferably 0 to 180° C., and more preferably 30 to 150° C. If the temperature condition of the solvent removal treatment is lower than the lower limit, it tends to be difficult to remove sufficiently the solvent by evaporation. Meanwhile, if the temperature condition exceeds the upper limit, boiling of the solvent tends to results in a film containing bubbles or voids. In this case, for example, when a film-shaped polyimide is produced, it is only necessary to apply the obtained reaction liquid directly onto a substrate (for example, a glass plate) and conduct the treatment for removing the solvent by evaporation and the heating treatment. Thus, the film-shaped polyimide can be produced by a simple and convenient method. Note that a method for applying the reaction liquid is not particularly limited, and a known method (cast method or the like) can be employed, as appropriate. In addition, when the above-described polyamic acid of the present invention is used after being isolated from the reaction liquid, a method for the isolation is not particularly limited, and a known method capable of isolating a polyamic acid can be employed, as appropriate. For example, a method for isolation as reprecipitates or the like may be employed.

In addition, when the step (II) is conducted by employing the method in which the imidization is conducted by performing the heating treatment, the step (I) and the step (II) may be conducted simultaneously as a series of steps. As a method for conducting the step (I) and the step (II) simultaneously as a series of steps as described above, for example, a method can be employed in which the step (I) and the step (II) are conducted simultaneously by conducting the heating treatment starting at the stage of reacting at least one compound (tetracarboxylic dianhydride) selected from the group consisting of the raw material compound (A) represented by the above-described general formula (101), the raw material compound (B) represented by the above-described general formula (201), and the raw material compound (C) represented by the above-described general formula (301) with the aromatic diamine represented by the general formula (102) to cause the formation of the polyamic acid (intermediate) and the subsequent formation of the polyimide (imidization) to proceed almost simultaneously.

In addition, when the step (I) and the step (II) are conducted simultaneously by conducting the heating treatment starting at the stage of reacting the tetracarboxylic dianhydride with the aromatic diamine as described above, it is preferable to form the polyimide by using a reaction accelerator from the stage of reacting the above-described tetracarboxylic dianhydride with the above-described aromatic diamine in the presence of an organic solvent, and reacting at least one compound (tetracarboxylic dianhydride) selected from the group consisting of the raw material compound (A) represented by the above-described general formula (101), the raw material compound (B) represented by the above-described general formula (201), and the raw material compound (C) represented by the above-described general formula (301) with the aromatic diamine represented by the general formula (102) under heating in the presence of the organic solvent and the reaction accelerator. When the step (I) and the step (II) are conducted simultaneously as described above, the heating causes the formation of the polyamic acid in the step (I) and the imidization of the polyamic acid in the step (II) successively, so that the polyimide is prepared in the solvent. By using the reaction accelerator here, the reaction rates of the formation of the polyamic acid and the imidization are extremely increased, so that the molecular weight can be increased. In addition, when the step (I) and the step (II) are conducted simultaneously by heating while using the reaction accelerator, the heating causes the reaction of the tetracarboxylic dianhydride with the aromatic diamine to proceed, and also makes it possible to remove by evaporation water formed by the reaction. Hence, it is also possible to cause the reaction to proceed efficiently without using a so-called condensation agent (dehydration condensation agent).

In addition, when the polyimide is formed by reacting the tetracarboxylic dianhydride represented by the above-described general formula (5) with the aromatic diamine under heating in the presence of the organic solvent and the reaction accelerator (when the step (I) and the step (II) are conducted simultaneously by heating while using the reaction accelerator), a temperature condition of the heating is preferably 100 to 250° C., more preferably 120 to 250° C., and further preferably 150 to 220° C. If the temperature condition is lower than the lower limit, it tends to be difficult to obtain the polyimide with a high molecular weight, because the reaction temperature is not higher than the boiling point of water, and hence the removal of water by distillation does not occur, so that the progress of the reaction is inhibited by water. Meanwhile, if the temperature condition exceeds the upper limit, side reactions such as thermal decomposition of the solvent tends to occur, so that the amount of impurities increases in a mixture liquid (varnish) of the polyimide and the organic solvent obtained after the heating. As a result, when a film is formed by using the mixture liquid, physical properties of the obtained polyimide film tend to deteriorate.

In addition, when the step (I) and the step (II) are conducted simultaneously by heating while using the reaction accelerator, the reaction accelerator used in the steps is preferably a tertiary amine such as triethylamine, diisopropylethylamine, N-methylpiperidine, pyridine, collidine, lutidine, 2-hydroxypyridine, 4-dimethylaminopyridine (DMAP), 1,4-diazabicyclo[2.2.2]octane (DABCO), diazabicyclononene (DBN), or diazabicycloundecene (DBU) Among these, triethylamine, diisopropylethylamine, N-methylpiperidine, and pyridine are preferable, triethylamine, pyridine, and N-methylpiperidine are more preferable, and triethylamine and N-methylpiperidine are further preferable from the viewpoints of reactivity, availability, and practicability. One of these reaction accelerators may be used alone, or two or more thereof may be used in combination. In addition, when the step (I) and the step (II) are conducted simultaneously by heating while using the reaction accelerator, the amount of the reaction accelerator used is preferably 0.01 to 10 parts by mass, and more preferably 0.05 to 2 parts by mass relative to 100 parts by mass of the total amount (sum) of the tetracarboxylic dianhydride represented by the above-described general formula (5) and the aromatic diamine.

Hereinabove, the method which can be preferably employed as a method for producing the above-described polyimide of the present invention has been described.

Next, a polyamic acid solution of the present invention is described.

[Polyamic Acid Solution]

A polyamic acid solution of the present invention comprises the above-described polyamic acid of the present invention; and an organic solvent. The same organic solvents as those used for the above-described method which can be preferably employed as a method for producing a polyamic acid can be preferably used as the organic solvent used for the polyamic acid solution (resin solution: varnish). For this reason, the polyamic acid solution of the present invention may be prepared in such a manner that the above-described method which can be preferably employed as a method for producing a polyamic acid is conducted, and the reaction liquid obtained after the reaction is directly used as the polyamic acid solution.

The amount of the polyamic acid contained in the polyamic acid solution is not particularly limited, and is preferably 1 to 80% by mass, and more preferably 5 to 50% by mass. If the amount of the polyamic acid contained is less than the lower limit, it tends to be difficult to produce a polyimide film. Meanwhile, if the amount exceeds the upper limit, it also tends to be difficult to produce a polyimide film. Note that the polyamic acid solution can be used preferably to produce the above-described polyimide of the present invention, and can be used preferably to produce a polyimide in various shapes. For example, it is also possible to produce easily a film-shaped polyimide by applying such a polyamic acid solution onto any of various substrates, followed by curing by imidization.

Hereinabove, the polyamic acid solution of the present invention has been described. Next, a polyimide solution of the present invention is described.

[Polyimide Solution]

A polyimide solution of the present invention comprises: the above-described polyimide of the present invention; and an organic solvent. The same organic solvents as those described above for the method which can be preferably employed as a method for producing a polyamic acid can be preferably used as the organic solvent used for the polyimide solution. In addition, regarding the polyimide solution of the present invention, when the polyimide obtained by conducting the above-described method which can be preferably employed as a method for producing a polyimide is soluble in the organic solvent used for the production, the reaction liquid obtained after the reaction may be directly prepared as the polyimide solution.

In addition, the polyimide solution of the present invention may also be produced by obtaining a solution containing the polyamic acid and the organic solvent such that the reaction liquid (the reaction liquid containing the above-described polyamic acid of the present invention) obtained by reacting at least one compound (tetracarboxylic dianhydride) selected from the group consisting of the raw material compound (A) represented by the above-described general formula (101), the raw material compound (B) represented by the above-described general formula (201), and the raw material compound (C) represented by the above-described general formula (301) with the aromatic diamine represented by the general formula (102) in an organic solvent is used directly (the reaction liquid obtained after the step (I) described above for the method which can be preferably employed as a method for producing a polyimide is conducted without isolation of the polyamic acid is used directly), and the imidization is conducted by adding an imidization agent to the reaction liquid to prepare the polyimide in the organic solvent.

As described above, the same organic solvents as those described above for the method which can be preferably employed as a method for producing a polyamic acid can be preferably used as the organic solvent used for the polyimide solution of the present invention. Note that, as the organic solvent used for the polyimide solution of the present invention, it is possible to use a halogen-based solvent having a boiling point of 200° C. or lower (such as dichloromethane (boiling point: 40° C.), trichloromethane (boiling point: 62° C.), carbon tetrachloride (boiling point: 77° C.), dichloroethane (boiling point: 84° C.), trichloroethylene (boiling point: 87° C.), tetrachloroethylene (boiling point: 121° C.), tetrachloroethane (boiling point: 147° C.), chlorobenzene (boiling point: 131° C.), or o-dichlorobenzene (boiling point: 180° C.)) or the like, for example, from the viewpoints of the transpiration properties and removability of the solvent in a case where the polyimide solution is used as a coating liquid.

In addition, the organic solvent used for the polyimide solution is preferably N-methyl-2-pyrrolidone, N,N-dimethylacetamide, γ-butyrolactone, propylene carbonate, tetramethylurea, or 1,3-dimethyl-2-imidazolidinone, more preferably N-methyl-2-pyrrolidone, N,N-dimethylacetamide, γ-butyrolactone, or tetramethylurea, and particularly preferably N,N-dimethylacetamide or γ-butyrolactone, from the viewpoints of the solubility, film formability, productivity, industrial availability, the presence or absence of existing facilities, price, and the like. Note that one of these organic solvents may be used alone, or two or more thereof may be used in combination.

In addition, the polyimide solution can also be preferably used as a coating liquid for producing various processed products or the like. For example, when a film is formed, the polyimide film may be formed by using the above-described polyimide solution of the present invention as a coating liquid in such a manner that the coating liquid is applied onto a substrate to obtain a coating film, and then the solvent is removed. The application method is not particularly limited, and a known method (spin-coating method, bar-coating method, dip-coating method, or the like) can be used, as appropriate.

The amount of the polyimide contained (the amount of the polyimide dissolved) in the polyimide solution is not particularly limited, and is preferably 1 to 75% by mass, and more preferably 10 to 50% by mass. If the amount contained is less than the lower limit, the film thickness after film formation tends to be small when the polyimide solution is used for the film formation or the like. Meanwhile, if the amount contained exceeds the upper limit, the polyimide tends to be partially insoluble in the solvent. Moreover, the polyimide solution may further comprise additives such as an antioxidant (a phenol-based, phosphite-based, or thioether-based antioxidant or the like), an ultraviolet absorber, a hindered amine-based light stabilizer, a nucleating agent, resin additives (filler, talc, glass fiber, and the like), a flame retardant, a processability improver, a lubricant, and the like, according to the purpose of use and the like. Note that these additives are not particularly limited, and known additives can be used, as appropriate. Commercially available ones may also be used.

Hereinabove, the polyimide solution of the present invention has been described. Next, a film of the present invention is described.

[Polyimide Film]

A polyimide film of the present invention comprises the above-described polyimide of the present invention. As described above, the polyimide film of the present invention only needs to be a film comprising a polyimide described above as the polyimide of the present invention.

Moreover, the thickness of the polyimide film of the present invention is not particularly limited, and preferably 1 to 500 μm, and more preferably 10 to 200 μm. If the thickness is less than the lower limit, the strength tends to decrease, making the film difficult to handle. Meanwhile, if the thickness exceeds the upper limit, it tends to be necessary to perform application multiple times, or the process tends to be complicated.

The form of the polyimide film is not particularly limited, as long as the polyimide film is in the form of a film. The polyimide film can be designed in various shapes (a disk shape, a cylindrical shape (a shape obtained by processing a film into a tubular shape), and the like), as appropriate. When the polyimide film is produced by using the above-described polyimide solution, it is also possible to change the design of the polyimide film more easily.

A method for preparing the film (polyimide film) of the present invention is not particularly limited, and, for example, it is possible to employ a method in which the polyimide film is prepared by applying the above-described polyamic acid solution of the present invention onto a substrate followed by solvent removal and imidization or a method in which the polyimide film is prepared by applying the above-described polyimide solution of the present invention onto a substrate followed by solvent removal.

Since the polyimide film of the present invention is made of the above-described polyimide of the present invention, the polyimide film not only can be sufficiently excellent in transparency and heat resistance, but also can have a sufficiently high hardness. For this reason, the polyimide film of the present invention can be used, as appropriate, for example, in applications such as films for flexible wiring boards, films used for liquid crystal orientation films, transparent electrically conductive films for organic EL, films for organic EL lighting devices, flexible substrate films, substrate films for flexible organic EL, flexible transparent electrically conductive films, transparent electrically conductive films, transparent electrically conductive films for organic thin film-type solar cells, transparent electrically conductive films for dye-sensitized-type solar cells, flexible gas barrier films, films for touch panels, front films for flexible displays, back films for flexible displays, TFT substrate films for flat panel detectors, polyimide belts, coating agents, barrier films, sealants, interlayer insulating materials, passivation films, TAB (Tape Automated Bonding) tapes, optical waveguides, color filter base materials, semiconductor coating agents, heat-resistant insulating tapes, enameled wires, and the like.

### EXAMPLES

Hereinafter, the present invention is described more specifically on the basis of Examples; however, the present invention is not limited to Examples below.

[Regarding Methods for Characterization]

First, methods for characterization of compounds and the like obtained in Examples and the like are described.

<Identification of Molecular Structure>

The molecular structure of the polyimide obtained in each Example or the like was identified by infrared absorption spectrometry (IR measurement). Note that a measuring apparatus manufactured by JASCO Corporation under the trade name of “FT/IR-4100” was used for the measurement.

<Total Luminous Transmittance>

The total luminous transmittance (unit: %) was determined by conducting measurement according to JIS K7361-1 (published in 1997) while using the polyimide (film-shaped polyimide) obtained in each Example or the like, as it was, as a measurement sample, and using a measuring apparatus manufactured by NIPPON DENSHOKU INDUSTRIES CO., LTD. under the trade name of “Haze Meter NDH-5000”.

<Measurement of Glass Transition Temperature (Tg)>

The value (unit: ° C.) of the glass transition temperature (Tg) of the polyimide obtained in each Example or the like was determined as follows. Specifically, by using a thermomechanical analyzer (manufactured by Rigaku Corporation under the trade name of “TMA8311”) as a measuring apparatus, and further by using a sample cut out of the polyimide film obtained in each Example or the like and having a size of 20 mm in length and 5 mm in width as a measurement sample (since the thickness of the sample does not exert any influence on the measured value, the thickness of the film obtained in each Example was used as it was), a TMA curve was obtained by conducting measurement under a nitrogen atmosphere and under conditions of a tensile mode (49 mN) and a rate of temperature rise of 5° C./min. Then, a curve before and after the inflection point of the TMA curve attributable to the glass transition was extrapolated to determine the glass transition temperature (Tg).

<Measurement of Linear Expansion Coefficient (CTE)>

The value of the linear expansion coefficient (CTE) of the polyimide obtained in each Example or the like was determined as follows. Specifically, first, by using a thermomechanical analyzer (manufactured by Rigaku Corporation under the trade name of “TMA8311”) as a measuring apparatus, and by using a sample cut out of the polyimide film obtained in each Example or the like and having a size of 20 mm in length and 5 mm in width as a measurement sample (since the thickness of the sample does not exert any influence on the measured value, the thickness of the film obtained in each Example was used as it was), the temperature was raised from room temperature to 200° C. (first temperature rise) by employing conditions of a tensile mode (49 mN) and a rate of temperature rise of 5° C./min under a nitrogen atmosphere, and the temperature was allowed to drop to 30° C. or lower. Then, the temperature was raised from that temperature to 400° C. (second temperature rise). During this temperature rise, the change in length of the sample in the longitudinal direction is measured. Subsequently, a TMA curve obtained by the measurement during the second temperature rise (the measurement during the temperature rise from the temperature after the temperature drop to 400° C.) was used to determine the average value of the changes in length per degree Celsius in the temperature range from 100° C. to 200° C. The obtained value was employed as the linear expansion coefficient of the polyimide in the measurement.

### Synthesis Example 1: Synthesis of Tetracarboxylic Dianhydride A

As a tetracarboxylic dianhydride A, norbornane-2-spiro-α-cyclopentanone-α′-spiro-2″-norbornane-5,5″,6,6″-tetracarboxylicdianhydride (CpODA) represented by the following general formula (I) was synthesized:

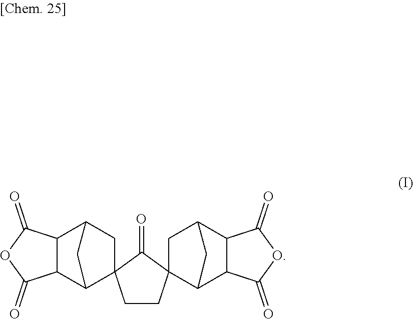

Note that the tetracarboxylic dianhydride A (the compound represented by the general formula (I)) was synthesized according to the method described in Synthesis Example 1, Example 1, and Example 2 of International Publication No. WO2011/099518.

### Synthesis Example 2: Synthesis of Tetracarboxylic Dianhydride B

As a tetracarboxylic dianhydride B, a compound (BzDA) represented by the following general formula (II) was synthesized:

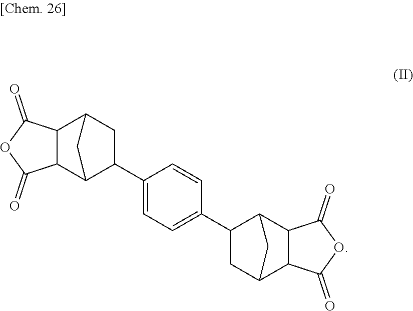

Note that the tetracarboxylic dianhydride B was synthesized according to the method described in Example 1 of International Publication No. WO2015/163314.

### Synthesis Example 3: Synthesis of Tetracarboxylic Dianhydride C

As a tetracarboxylic dianhydride C, a compound (BNBDA) represented by the following general formula (III) was synthesized:

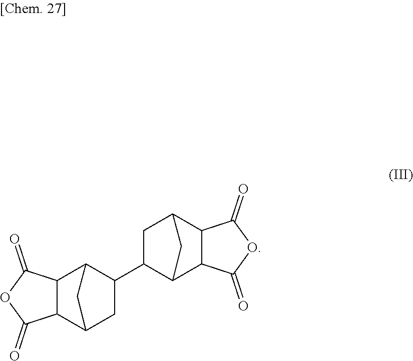

Note that the tetracarboxylic dianhydride C was produced as follows.

Specifically, first, 5,5′-bibicyclo[2.2.1]hept-2-ene (BNB, 557 g, 2.99 mol) and toluene (1.8 kg) were added into a 3 L recovery flask and sufficiently mixed with each other to obtain a uniform solution (BNB-toluene solution). Next, the atmospheric gas inside a 50 L glass-lined reactor (GL reactor) was replaced with nitrogen, and then methanol (13.1 kg), CuCl₂(II) (1.65 kg, 12.3 mol), and Pd₃(OAc)₅(NO₂) (3.4 g, 0.0149 mol)) were added into the reactor to obtain a mixture liquid.

Next, the pressure inside the reactor was reduced to −0.08 MPaG, and then the pressure inside the reactor was adjusted to 0.03 MPaG by introducing carbon monoxide into the reactor. Subsequently, the mixture liquid was stirred for 4 hours with the temperature inside the reactor being 25° C. Then, while the stirring was continued, the temperature inside the reactor was raised gradually to 40° C., and the stirring was continued under a temperature condition of 40° C. for further 4 hours. Then, the stirring of the mixture liquid was stopped, and the mixture liquid was allowed to stand overnight (13.5 hours) to obtain a reaction liquid as a brown suspension.

Next, the pressure was reduced by removing the atmospheric gas containing carbon monoxide from the inside of the reactor, and the atmospheric gas inside the reactor was replaced with nitrogen. Subsequently, the temperature was raised to 50° C., while nitrogen was being passed through the inside of the reactor, and it was confirmed that the concentration of carbon monoxide in the gas (outlet gas) emitted from the reactor was 0 ppm. After that, methanol was removed by distillation from the reaction liquid in the reactor by further raising the temperature inside the reactor to 65° C. to obtain a solid. Next, toluene (20 kg) was added into the reactor, in which the solid had precipitated, to obtain a mixture of the solid and toluene. Then, to remove methanol from the mixture completely, the pressure inside the reactor was reduced to −0.07 MPaG and the temperature was raised to 73° C. to remove a portion of the solvent in the mixture by distillation. Subsequently, toluene (5.0 kg) was further added into the mixture. Then, the temperature was raised to 80° C. with stirring followed by filtration to recover the precipitates (solid) and the filtrate separately. Next, the obtained precipitates were washed with toluene (5.0 kg), and the washing liquid was added to the above-described filtrate. Subsequently, the filtrate was washed twice with 5% hydrochloric acid (1.0 kg), once with saturated aqueous sodium hydrogen carbonate (10 kg), and once with ion-exchanged water (10 kg), while being kept at a temperature of 80° C. by heating. After the washing as described above, the obtained organic layer was filtered through a filter to remove (separate) the solid precipitated in the washing liquid. Thus, an organic layer was obtained. Subsequently, the solid, which had been removed from the washing liquid, was washed with toluene (5.0 kg), and then the washing liquid was added to the above-described organic layer. The organic layer was again placed in the 50 L reactor, and toluene was distilled off by raising the temperature to 110° C. with stirring (the amount of toluene distilled off was 23 Kg). Then, the heating was stopped, and recrystallization was conducted by gradually cooling the reactor. Thus, a solid (crystals) was precipitated. The thus obtained solid (crystals) was collected by filtration, washed four times with toluene (0.6 kg), and dried in vacuo at 60° C. By these operations, 873 g of a product (white crystals: 5,5′-bi-2-norbornene-5,5′,6,6′-tetracarboxylic acid tetramethyl ester: BNBTE) was obtained.

Next, a 50 L GL reactor was purged with nitrogen, and the above-described product (BNBTE, 850 g, 2.01 mol), acetic acid (12.2 kg), and trifluoromethanesulfonic acid (7.6 g, 0.050 mol) were added to obtain a mixture liquid. Next, the temperature of the mixture liquid was raised to 113° C. and kept at the temperature (113° C.). Then, a step of distilling off the vapor (acetic acid and the like) was conducted, while adding dropwise acetic acid with a pump to keep the amount of the liquid in the reactor constant. Note that, it was found in this step that white precipitates were formed in the liquid (in the reaction solution) in the flask after 15 minutes had passed since the start of the removal of the vapor by distillation. In addition, the distillate removed by distillation to the outside of the system was analyzed by mass measurement and with a gas chromatograph every single hour in this step to check the degree of the progress of the reaction. Note that the analyses showed that acetic acid, methyl acetate, and water were present in the distillate. Then, methyl acetate ceased to be distilled off after 6 hours had passed since the start of the removal of the vapor by distillation in this step. Accordingly, heating was stopped, and recrystallization was conducted by gradually cooling to room temperature (25° C.). The obtained crystals were filtered, and washed once with acetic acid (0.6 kg), and five times with ethyl acetate (0.5 kg). Then, the crystals were dried in vacuo. Thus, 586 g of 5,5′-bi-2-norbornene-5,5′,6,6′-tetracarboxylic acid-5,5′,6,6′-dianhydride (the compound represented by the above-described general formula (III): BNBDA) was obtained.

### Example 1

First, under a nitrogen atmosphere, 3.48 g (10.0 mmol) of 9,9-bis (4-aminophenyl) fluorene (manufactured by Tokyo Chemical Industry Co., Ltd.: FDA) represented by the following general formula (110):

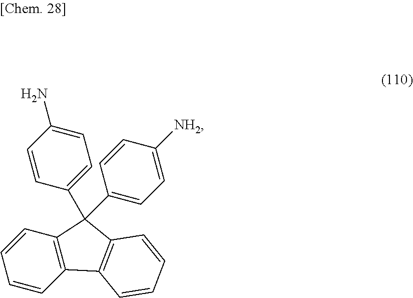

which was an aromatic diamine, and 3.84 g (10.0 mmol) of the above-described compound (tetracarboxylicdianhydride A: CpODA) represented by the general formula (I), which was a tetracarboxylic dianhydride, were introduced into a 50 mL screw cap tube to introduce the aromatic diamine (FDA) and the tetracarboxylic dianhydride A (CpODA) into the screw cap tube.

Next, 16.4 g of dimethylacetamide (N,N-dimethylacetamide), which was an organic solvent, 12.9 g of γ-butyrolactone, which was an organic solvent, and 0.051 g (0.50 mmol) of triethylamine, which was a reaction accelerator, were introduced into the screw cap tube. Thus, the aromatic diamine (FDA), the tetracarboxylic dianhydride A (CpODA), the organic solvents (N,N-dimethylacetamide and γ-butyrolactone), and the reaction accelerator (triethylamine) were mixed together to obtain a mixture liquid.

Subsequently, the thus obtained mixture liquid was stirred for 3 hours under a nitrogen atmosphere, while being heated under a temperature condition of 180° C. to obtain a viscous uniform light yellow reaction liquid (polyimide solution). Thus, a polyimide derived from the aromatic diamine (FDA) and the tetracarboxylic dianhydride (CpODA) was prepared by the heating step to obtain a reaction liquid (a solution of the polyimide). Note that it is obvious that the heating first caused the reaction between the aromatic diamine (FDA) and the tetracarboxylicdianhydride (CpODA) to proceed to form a polyamic acid, and then caused the imidization of the polyamic acid to proceed to form the polyimide.

Next, a glass plate (length: 75 mm, width: 50 mm, and thickness: 1.3 mm) was spin coated with the reaction liquid to form a coating film on the glass plate. After that, the glass plate on which the coating film was formed was placed into an oven, and the coating film was cured under a nitrogen atmosphere by first being allowed to stand under a temperature condition (first temperature condition) of 60° C. for 4 hours, and then being allowed to stand for 1 hour with the temperature condition changed to 300° C. (second temperature (calcination temperature) condition). Thus, a polyimide-coated glass was obtained in which the glass plate was coated with a thin film (polyimide film) made of a polyimide. Next, the thus obtained polyimide-coated glass was immersed in water at 90° C. for 0.5 hours to detach the polyimide film from the glass substrate. Thus, the polyimide film was recovered to obtain a colorless transparent film (polyimide film) made of polyimide. The thus obtained polyimide film had a film thickness of 32 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl and CpODA were observed at 1702 cm⁻¹ and 1774 cm⁻¹, indicating that the compound constituting the obtained film was a polyimide. Table 1 shows the results of the characterization of the obtained polyimide film.

### Example 2

A colorless transparent film (polyimide film) made of a polyimide was obtained in the same manner as in Example 1, except that a mixture of 1.74 g (5.00 mmol) of the above-described compound (FDA) represented by the general formula (110) and 1.06 g (5.00 mmol) of 4,4′-diamino-2,2′-dimethylbiphenyl (m-Tol) was used as the aromatic diamine instead of 3.48 g (10.0 mmol) of the above-described compound (FDA) represented by the general formula (110) alone, that the amount of dimethylacetamide (N,N-dimethylacetamide) used was changed from 16.4 g to 15.4 g, that the amount of γ-butyrolactone used was changed from 12.9 g to 11.1 g, and that the second temperature (calcination temperature) condition for curing the coating film was changed from 300° C. to 250° C. The thus obtained polyimide film had a film thickness of 70 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl and CpODA were observed at 1700 cm⁻¹ and 1774 cm⁻¹, indicating that the compound constituting the obtained film was a polyimide. In addition, Table 1 shows the results of the characterization of the obtained polyimide film.

### Example 3

A colorless transparent film (polyimide film) made of a polyimide was obtained in the same manner as in Example 1, except that a mixture of 1.74 g (5.00 mmol) of the above-described compound (FDA) represented by the general formula (110) and 1.00 g (5.00 mmol) of 4,4′-diaminodiphenyl ether (DDE) was used as the aromatic diamine instead of 3.48 g (10.0 mmol) of the above-described compound (FDA) represented by the general formula (110) alone, that 4.06 g (10.0 mmol) of the above-described compound (tetracarboxylic dianhydride B: BzDA) represented by the general formula (II), which was a tetracarboxylic dianhydride, was used instead of 3.84 g (10.0 mmol) of the above-described compound (tetracarboxylic dianhydride A: CpODA) represented by the general formula (I), which was a tetracarboxylic dianhydride, that the amount of dimethylacetamide (N,N-dimethylacetamide) used was changed from 16.4 g to 8.0 g, that the amount of γ-butyrolactone used was changed from 12.9 g to 7.9 g, that the amount of triethylamine used was changed from 0.051 g (0.50 mmol) to 0.056 g (0.55 mmol), and that the second temperature (calcination temperature) condition for curing the coating film was changed from 300° C. to 250° C. The thus obtained polyimide film had a film thickness of 30 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1701 and 1772 cm⁻¹, indicating that the compound constituting the obtained film was a polyimide. In addition, Table 1 shows the results of the characterization of the obtained polyimide film.

### Example 4

A colorless transparent film (polyimide film) made of a polyimide was obtained in the same manner as in Example 1, except that a mixture of 1.74 g (5.00 mmol) of the above-described compound (FDA) represented by the general formula (110) and 1.14 g (5.00 mmol) of 4,4′-diaminobenzanilide (DABAN) was used as the aromatic diamine instead of 3.48 g (10.0 mmol) of the above-described compound (FDA) represented by the general formula (110) alone, that 4.06 g (10.0 mmol) of the above-described compound (tetracarboxylic dianhydride B: BzDA) represented by the general formula (II), which was a tetracarboxylic dianhydride, was used instead of 3.84 g (10.0 mmol) of the above-described compound (tetracarboxylic dianhydride A: CpODA) represented by the general formula (I), which was a tetracarboxylic dianhydride, that the amount of dimethylacetamide (N,N-dimethylacetamide) used was changed from 16.4 g to 8.1 g, that the amount of γ-butyrolactone used was changed from 12.9 g to 8.2 g, that the amount of triethylamine used was changed from 0.051 g (0.50 mmol) to 0.055 g (0.54 mmol), and that the second temperature (calcination temperature) condition for curing the coating film was changed from 300° C. to 250° C. The thus obtained polyimide film had a film thickness of 32 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1699 and 1772 cm⁻¹, indicating that the compound constituting the obtained film was a polyimide. In addition, Table 1 shows the results of the characterization of the obtained polyimide film.

### Example 5

A colorless transparent film (polyimide film) made of a polyimide was obtained in the same manner as in Example 1, except that the amount of the above-described compound (FDA) represented by the general formula (110) used was changed from 3.48 g (10.0 mmol) to 2.09 g (6.00 mmol), that a mixture of 0.66 g (2.00 mmol) of the above-described compound (tetracarboxylic dianhydride C: BNBDA) represented by the general formula (III), which was a tetracarboxylic dianhydride, and 0.90 g (4.00 mmol) of 1,2,4,5-cyclohexanetetracarboxylic dianhydride (HPMDA: manufactured by Tokyo Chemical Industry Co., Ltd.) was used instead of 3.84 g (10.0 mmol) of the above-described compound (tetracarboxylic dianhydride A: CpODA) represented by the general formula (I), which was a tetracarboxylic dianhydride, that the amount of dimethylacetamide (N,N-dimethylacetamide) used was changed from 16.4 g to 4.4 g, that the amount of γ-butyrolactone used was changed from 12.9 g to 4.3 g, and that the second temperature (calcination temperature) condition for curing the coating film was changed from 300° C. to 250° C. The thus obtained polyimide film had a film thickness of 32 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1702 and 1774 cm⁻¹, indicating that the compound constituting the obtained film was a polyimide. In addition, Table 1 shows the results of the characterization of the obtained polyimide film.

### Comparative Example 1

Preparation of a polyimide film was attempted in the same manner as in Example 1, except that 2.24 g (10.0 mmol) of 1,2,4,5-cyclohexanetetracarboxylic dianhydride (HPMDA: manufactured by Tokyo Chemical Industry Co., Ltd.) was used as the tetracarboxylic dianhydride instead of the above-described compound (tetracarboxylic dianhydride A: CpODA) represented by the general formula (I), that the amount of dimethylacetamide (N,N-dimethylacetamide) used was changed from 16.4 g to 11.7 g, and that the amount of γ-butyrolactone used was changed from 12.9 g to 11.1 g. However, the obtained film was brittle and unable to maintain the film shape sufficiently, so that the film was not usable for various analyses (the film was so brittle that the characterization was impossible).

### Comparative Example 2

A colorless transparent film (polyimide film) made of a polyimide was obtained in the same manner as in Example 1, except that 4.32 g (10.0 mmol) of bis[4-(4-aminophenoxy)phenyl] sulfone (BAPS: manufactured by Tokyo Chemical Industry Co., Ltd.) was used as the aromatic diamine instead of 3.48 g (10.0 mmol) of the above-described compound (FDA) represented by the general formula (110) alone, that the amount of dimethylacetamide (N,N-dimethylacetamide) used was changed from 16.4 g to 18.5 g, that the amount of γ-butyrolactone used was changed from 12.9 g to 11.1 g, and that the second temperature (calcination temperature) condition for curing the coating film was changed from 300° C. to 250° C. The thus obtained polyimide film had a film thickness of 31 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl and CpODA were observed at 1702 cm⁻¹ and 1774 cm⁻¹, indicating that the compound constituting the obtained film was a polyimide. In addition, Table 1 shows the results of the characterization of the obtained polyimide film.

### Comparative Example 3

A colorless transparent film (polyimide film) made of a polyimide was obtained in the same manner as in Example 1, except that 2.24 g (10.0 mmol) of dicyclohexyl-3,4,3′,4′-tetracarboxylic dianhydride (H-BPDA: manufactured by LEAPChem) was used instead of 3.84 g (10.0 mmol) of the above-described compound (tetracarboxylic dianhydride A: CpODA) represented by the general formula (I), which was a tetracarboxylic dianhydride, that the amount of dimethylacetamide (N,N-dimethylacetamide) used was changed from 16.4 g to 12.7 g, that the amount of γ-butyrolactone used was changed from 12.9 g to 6.7 g, and that the second temperature (calcination temperature) condition for curing the coating film was changed from 300° C. to 250° C. The thus obtained polyimide film had a film thickness of 33 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1703 and 1778 cm⁻¹, indicating that the compound constituting the obtained film was a polyimide. In addition, Table 1 shows the results of the characterization of the obtained polyimide film.

### Comparative Example 4

Production of a polyimide film was attempted by employing the same method as employed in Example 1, except that 1.96 g (10.0 mmol) of 1,2,3,4-cyclobutanetetracarboxylic dianhydride (CBDA: manufactured by Tokyo Chemical Industry Co., Ltd.) was used as the tetracarboxylic dianhydride instead of the above-described compound (tetracarboxylic dianhydride A: CpODA) represented by the general formula (I), that the amount of dimethylacetamide (N,N-dimethylacetamide) used was changed from 16.4 g to 6.4 g, that the amount of γ-butyrolactone used was changed from 12.9 g to 6.4 g, and that the amount of triethylamine used was changed from 0.051 g (0.50 mmol) to 0.055 g (0.54 mmol). However, in the step of obtaining a mixture liquid and then preparing a reaction liquid (polyimide solution: the reaction liquid used to form a coating film) by using the mixture liquid, the mixture liquid was heated under a nitrogen atmosphere and under a temperature condition of 180° C. for 3 hours, but white precipitates were formed, and it was impossible to prepare a uniform reaction liquid (varnish). As described above, when CBDA was used instead of CpODA, it was impossible to obtain the varnish for forming a film in the first place, and it was impossible to form the coating film, because the solubility of the polyimide derived from CBDA in the reaction solvent was so low.

### Comparative Example 5

A colorless transparent film (polyimide film) made of a polyimide was obtained in the same manner as in Example 1, except that 3.20 g (10.0 mmol) of 2,2′-bis(trifluoromethyl)-4,4′-diaminobiphenyl (TFMB: manufactured by Seika Corporation) was used as the aromatic diamine instead of 3.48 g (10.0 mmol) of the above-described compound (FDA) represented by the general formula (110) alone, that 4.06 g (10.0 mmol) of the above-described compound (tetracarboxylic dianhydride B: BzDA) represented by the general formula (II), which was a tetracarboxylic dianhydride, was used instead of 3.84 g (10.0 mmol) of the above-described compound (tetracarboxylic dianhydride A: CpODA) represented by the general formula (I), which was a tetracarboxylic dianhydride, that the amount of dimethylacetamide (N,N-dimethylacetamide) used was changed from 16.4 g to 8.5 g, that the amount of γ-butyrolactone used was changed from 12.9 g to 8.5 g, and that the second temperature (calcination temperature) condition for curing the coating film was changed from 300° C. to 250° C. The thus obtained polyimide film had a film thickness of 23 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1710 and 1778 cm⁻¹, indicating that the compound constituting the obtained film was a polyimide. In addition, Table 1 shows the results of the characterization of the obtained polyimide film.

### Comparative Example 6

Under a nitrogen atmosphere, 5.95 g (18.0 mmol) of the above-described compound (tetracarboxylicdianhydride C: BNBDA) represented by the general formula (III), which was a tetracarboxylic dianhydride, 3.61 g (18.0 mmol) of 4,4′-diaminodiphenyl ether (DDE, manufactured by Tokyo Kagaku Kougyou Co., Ltd.), and 38.2 g of N,N′-dimethylacetamide were added into a screw cap tube, and stirred at room temperature for 10 hours. A viscous and uniform solution (varnish) was obtained. Next, a glass plate (length: 100 mm, width: 100 mm, thickness: 1.0 mm) was spin coated with the above-described reaction liquid to form a coating film on the glass plate. After that, the glass plate on which the coating film has been formed was placed into an oven, and the coating film was cured under a nitrogen atmosphere by first being allowed to stand under a temperature condition (first temperature condition) of 60° C. for 4 hours, and then being allowed to stand for 1 hour with the temperature condition changed to 350° C. (second temperature (calcination temperature) condition). Thus, a polyimide-coated glass was obtained in which the glass plate was coated with a thin film (polyimide film) made of a polyimide. Next, the thus obtained polyimide-coated glass was immersed in water at 90° C. for 0.5 hours to detach the polyimide film from the glass substrate. Thus, the polyimide film was recovered to obtain a colorless transparent film (polyimide film) made of a polyimide. The thus obtained polyimide film had a film thickness of 9 μm.

Note that, to identify the molecular structure of the compound forming the thus obtained film, an IR spectrum was measured by using an IR spectrometer (manufactured by JASCO Corporation, trade name: FT/IR-4100), and C═O stretching vibrations of imidocarbonyl were observed at 1701 and 1774 cm⁻¹, indicating that the compound constituting the obtained film was a polyimide. In addition, Table 1 shows the results of the characterization of the obtained polyimide film.

TABLE 1

| | Type of | Type of | Second | | | | | | |
|---|---|---|---|---|---|---|---|---|---|
| | tetracarboxylic | aromatic | temperature | | | Total | | | |
| | dianhydride | diamine | [Calcination | Film | | luminous | | | |
| | (Mole ratio in | (Mole ratio in | temperature] | thickness | Tg | transmittance | | | CTE |
| | parentheses) | parentheses) | (° C.) | (μm) | (° C.) | (%) | Haze | YI | (ppm/K) |
| Example 1 | CpODA | FDA | 300 | 32 | 475 | 90 | 0.8 | 0.8 | 48 |
| Example 2 | CpODA | FDA | 250 | 70 | 465 | 89 | 0.7 | 0.9 | 40 |
| | | m-Tol | | | | | | | |
| | | (1/1) | | | | | | | |
| Example 3 | BzDA | FDA | 250 | 30 | 386 | 89 | 1.5 | 1.2 | 61 |
| | | DDE | | | | | | | |
| | | (1/1) | | | | | | | |
| Example 4 | BzDA | FDA | 250 | 32 | 415 | 89 | 0.8 | 1.3 | 59 |
| | | DABAN | | | | | | | |
| | | (1/1) | | | | | | | |
| Example 5 | BNBDA | FDA | 250 | 32 | 451 | 89 | 1.2 | 1.3 | 46 |
| | HPMDA | | | | | | | | |
| | (1/2) | | | | | | | | |
| Comp. | HPMDA | FDA | 300 | Unmeasurable | | | | | |
| Ex. 1 | | | | (The film was so brittle as to be unanalyzable) | | | | | |
| Comp. | CpODA | BAPS | 250 | 31 | 339 | 89 | 0.3 | 0.2 | 44 |
| Ex. 2 | | | | | | | | | |
| Comp. | H-BPDA | FDA | 250 | 33 | 349 | 89 | 0.8 | 1.1 | 60 |
| Ex. 3 | | | | | | | | | |
| Comp. | CBDA | FDA | 250 | Unable to form film | | | | | |
| Ex. 4 | | | | (Unable to form varnish) | | | | | |
| Comp. | BzDA | TFMB | 250 | 23 | 347 | 91 | 0.7 | 0.9 | 70 |
| Ex. 5 | | | | | | | | | |
| Comp. | BNBDA | DDE | 350 | 9 | 348 | 89 | 0.5 | 1.3 | 55 |
| Ex. 6 | | | | | | | | | |

As is apparent from the results shown in Table 1, it was found that the polyimides described in Examples 1 and 2, each of which was obtained by reacting the tetracarboxylic dianhydride A (CpODA) with an aromatic diamine containing the above-described compound (9,9-bis(4-aminophenyl) fluorene:FDA) represented by the general formula (110), each had a glass transition temperature (Tg) of 465° C. or higher (note that it is apparent from the types of the compounds used and the like that a polyimide of the present invention having the above-described repeating unit (A1) was formed in each of Examples 1 and 2).

In contrast, in the case (Comparative Example 1) where 1,2,4,5-cyclohexanetetracarboxylic dianhydride (HPMDA), which was a tetracarboxylic dianhydrides other than the above-described tetracarboxylic dianhydrides A to C, was used, preparation of a film was attempted, but the prepared film was brittle and unable to maintain the film shape sufficiently. Hence, measurement of the glass transition temperature (Tg) was impossible.

Meanwhile, in the case (Comparative Example 4) where 1,2,3,4-cyclobutanetetracarboxylic dianhydride (CBDA), which was a tetracarboxylic dianhydride other than the above-described tetracarboxylic dianhydrides A to C, was used, it was impossible to prepare the reaction liquid (varnish) used to form a film in the first place, so that it was impossible to obtain a film. Moreover, in the case (Comparative Example 3) where dicyclohexyl-3,4,3′,4′-tetracarboxylic dianhydride (H-BPDA), which was a tetracarboxylic acid other than the above-described tetracarboxylic dianhydrides A to C, was used, the glass transition temperature (Tg) of the polyimide was 349° C.

In addition, in the case (Comparative Example 2) where an aromatic diamine other than the above-described compound (9,9-bis(4-aminophenyl) fluorene:FDA) represented by the general formula (110) was used, and the polyimide was formed by reacting the tetracarboxylic dianhydride A (CpODA) with bis[4-(4-aminophenoxy)phenyl] sulfone (BAPS), the glass transition temperature (Tg) of the polyimide was a sufficiently high value of 339° C. However, since the polyimides (Examples 1 and 2) of the present invention comprising the above-described repeating unit (A1) each had a glass transition temperature (Tg) of 465° C. or higher, it has been found that a higher level of heat resistance can be obtained by the polyimide of the present invention.

From these results, it has been found that the polyimides (Examples 1 and 2) of the present invention comprising the above-described repeating unit (A1) can achieve a higher level of heat resistance based on the glass transition temperature.

In addition, as is apparent from the results shown in Table 1, it was found that the polyimides described in Examples 3 and 4 obtained by reacting the tetracarboxylic dianhydride B (BzDA) with aromatic diamines including the above-described compound (FDA) represented by the general formula (110) each had a glass transition temperature (Tg) of 386° C. or higher (note that it is apparent from the types of the compounds used and the like that a polyimide of the present invention having the above-described repeating unit (B1) was formed in each of Examples 3 and 4). In contrast, in the case (Comparative Example 5) where 2,2′-bis(trifluoromethyl)-4,4′-diaminobiphenyl (TFMB), which was an aromatic diamine other than the above-described compound (FDA) represented by the general formula (110), was used, while the tetracarboxylic dianhydride B (BzDA) was used, the glass transition temperature (Tg) of the polyimide was 347° C. (Comparative Example 5). Moreover, in the cases (Comparative Examples 1, 3, and 4) where a tetracarboxylic dianhydride other than the above-described tetracarboxylic dianhydrides A to C was used, the glass transition temperatures (Tg) were 349° C. or lower (it was impossible to measure the glass transition temperature (Tg) in some of the cases). From the results of the comparison of Examples 3 and 4 with Comparative Examples 1 and 3 to 5, it has been found that the polyimides (Examples 3 and 4) of the present invention comprising the above-described repeating unit (B1) can achieve a higher level of heat resistance based on the glass transition temperature.

In addition, as is apparent from the results shown in Table 1, it was found that the polyimide described in Example 5 and obtained by reacting tetracarboxylic anhydrides including the tetracarboxylic dianhydride C (BNBDA) with the above-described compound (FDA) represented by the general formula (110) had a glass transition temperature (Tg) of 451° C. (note that it is apparent from the types of the compounds used and the like that a polyimide of the present invention having the above-described repeating unit (C1) was formed in Example 5). In contrast, in the case (Comparative Example 6) where the polyimide was formed by reacting the tetracarboxylic dianhydride C (BNBDA) with 4,4′-diaminodiphenyl ether (DDE), the glass transition temperature (Tg) of the polyimide was 348° C. (Comparative Example 6). Moreover, in the cases (Comparative Examples 1, 3, and 4) where a tetracarboxylic dianhydride other than the above-described tetracarboxylic dianhydrides A to C was used, the glass transition temperatures (Tg) were 349° C. or lower (it was impossible to measure the glass transition temperature (Tg) in some of the cases). From the results of the comparison of Example 5 with Comparative Examples 1, 3 to 4, and 6, it has been found that the polyimide (Example 5) of the present invention comprising the above-described repeating unit (C1) can achieve a higher level of heat resistance based on the glass transition temperature.

As described above, while the polyimides (Example 1 to 5) of the present invention comprising any one of the above-described repeating units (A1) to (C1) each had a glass transition temperature (Tg) of 386° C. or higher, the polyimides obtained in Comparative Example 1 to 6 each had a glass transition temperature (Tg) of 349° C. or lower (the glass transition temperature (Tg) of some of the polyimides was unmeasurable). Accordingly, it has been found that the polyimides (Example 1 to 5) of the present invention can achieve a higher level of heat resistance based on the glass transition temperature.

In addition, as is apparent from the description in Table 1, it was found that the polyimides (Example 1 to 5) of the present invention each had a total luminous transmittance of 89% or higher, indicating that the transparency was sufficiently high, and it was also found that the polyimides (Example 1 to 5) of the present invention each had a sufficiently low linear expansion coefficient (CTE) value of 61 ppm/K or lower (note that the linear expansion coefficients (CTEs) were 48 ppm/K or lower in Examples 1 and 2 and Example 5).

From the above-described results, the polyimides (Example 1 to 5) of the present invention can achieve a higher level of heat resistance based on the glass transition temperature, while having a sufficiently high transparency. Moreover, the polyimides (Example 1 to 5) of the present invention can have a sufficiently low linear expansion coefficient (CTE) value. Therefore, it has been found that the polyimides (Example 1 to 5) of the present invention are materials which can be preferably used in, for example, glass substitute application (various substrates and the like).

### INDUSTRIAL APPLICABILITY

As described above, according to the present invention, it is possible to provide a polyimide which can achieve a higher level of heat resistance based on the glass transition temperature, a polyimide solution comprising the polyimide, and a film using the polyimide. Moreover, according to the present invention, it is possible to provide a polyamic acid which can be preferably used to produce the polyimide, and a polyamic acid solution comprising the polyamic acid.

The polyimide of the present invention is useful, for example, as a material for producing films for flexible wiring boards, heat-resistant insulating tape, enameled wires, protective coating agents for semiconductors, liquid crystal orientation films, transparent electrically conductive films for organic EL, flexible substrate films, flexible transparent electrically conductive films, transparent electrically conductive films for organic thin film-type solar cells, transparent electrically conductive films for dye-sensitized-type solar cells, various gas barrier film substrates (such as flexible gas barrier films), films for touch panels, TFT substrate films for flat panel detectors, seamless polyimide belts (so-called transfer belts) for copiers, transparent electrode substrates (such as transparent electrode substrates for organic EL, transparent electrode substrates for solar cells, and transparent electrode substrates for electronic papers), interlayer insulating films, sensor substrates, image sensor substrates, reflective plates for light-emitting diodes (LEDs) (reflective plates for LED lighting devices: LED reflective plates), covers for LED lighting devices, covers for LED reflective plate lighting devices, coverlay films, high-ductility composite substrates, resists for semiconductors, lithium-ion batteries, substrates for organic memories, substrates for organic transistors, substrates for organic semiconductors, color filter substrates, and the like.

1. A polyimide, comprising at least one repeating unit selected from the group consisting of:
a repeating unit (A1) represented by the following general formula (1): 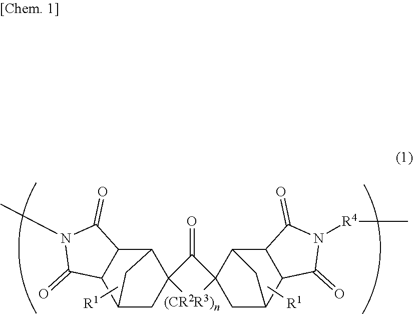
[in the formula (1), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the following general formula (X): 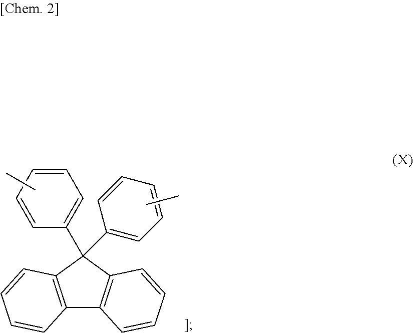
a repeating unit (B1) represented by the following general formula (2): 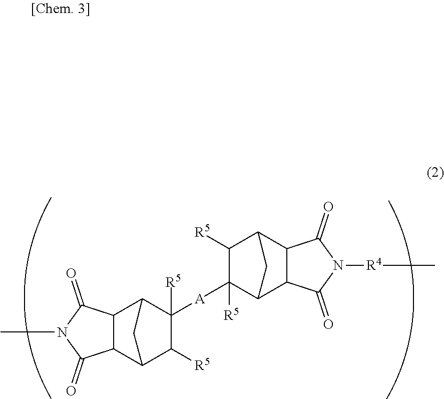
[in the formula (2), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms];
a repeating unit (C1) represented by the following general formula (3): 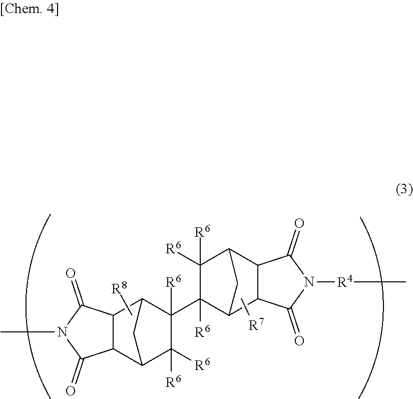
[in the formula (3), R⁴ represents an arylene group represented by the general formula (X), multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms].

2. A polyamic acid, comprising at least one repeating unit selected from the group consisting of:
a repeating unit (A2) represented by the following general formula (4): 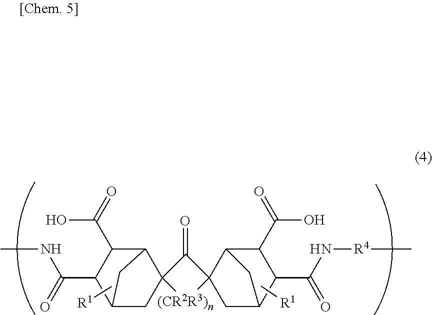
[in the formula (4), R¹s, R², and R³ each independently represent one selected from the group consisting of a hydrogen atom, alkyl groups having 1 to 10 carbon atoms, and a fluorine atom, n represents an integer of 0 to 12, and R⁴ represents an arylene group represented by the following general formula (X): 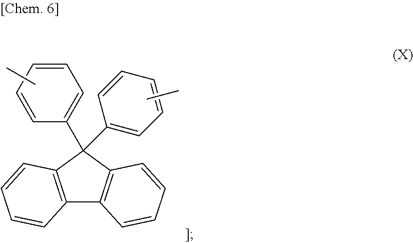
a repeating unit (B2) represented by the following general formula (5): 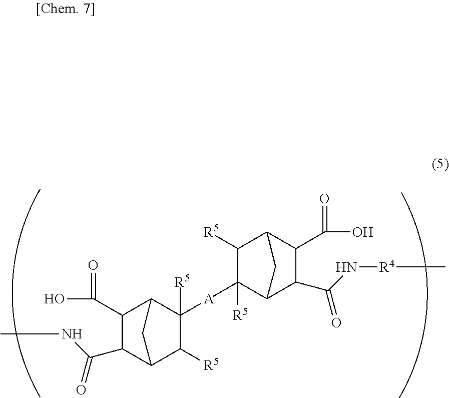
[in the formula (5), A represents one selected from the group consisting of optionally substituted divalent aromatic groups in each of which the number of carbon atoms forming an aromatic ring is 6 to 30, R⁴ represents an arylene group represented by the general formula (X), and multiple R⁵s each independently represent one selected from the group consisting of a hydrogen atom and alkyl groups having 1 to 10 carbon atoms]; and
a repeating unit (C2) represented by the following general formula (6): 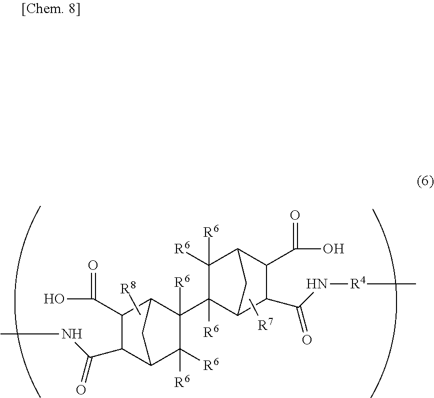
[in the formula (6), R⁴ represents an arylene group represented by the general formula (X), and multiple R⁶s each independently represent one selected from the group consisting of a hydrogen atom, alkyl groups having 1 to 10 carbon atoms, a hydroxy group, and a nitro group, or two R⁶s attached to the same carbon atom may together form a methylidene group, and R⁷ and R⁸ each independently represent one selected from the group consisting of a hydrogen atom and alkyl groups having 1 to 10 carbon atoms].

3. A polyimide solution, comprising:
the polyimide according to claim 1; and
an organic solvent.

4. A polyamic acid solution, comprising:
the polyamic acid according to claim 2; and
an organic solvent

5. A polyimide film, comprising the polyimide according to claim 1.
